(19) United States
(12) Patent Application Publication
(10) Pub. No.: US 2025/0047618 A1
(43) Pub. Date: Feb. 6, 2025

(54) RELAY DEVICE, COMMUNICATION SYSTEM, AND PROCESSING METHOD

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Kazuyuki Inoue, Yokkaichi-shi, Mie (JP); Hideki Maeda, Yokkaichi-shi, Mie (JP); Takeshi Hagihara, Yokkaichi-shi, Mie (JP); Tadashi Matsumoto, Yokkaichi-shi, Mie (JP); Kazuki Kitagawa, Yokkaichi-Shi, Mie (JP); Tatsuya Izumi, Osaka-shi, Osaka (JP); Hideyuki Tanaka, Osaka-Shi, Osaka (JP); Yojiro Suyama, Osaka-Shi, Osaka (JP)

(21) Appl. No.: 18/578,413

(22) PCT Filed: Jun. 23, 2022
(86) PCT No.: PCT/JP2022/025038

§ 371 Date: Jan. 11, 2024

(30) Foreign Application Priority Data
Jul. 14, 2021 (JP) 2021-116631

(51) Int. Cl. H04L 47/62; H04L 12/28; H04L 12/46

(52) U.S. Cl. CPC H04L 47/62; H04L 12/28; H04L 12/46

(57) ABSTRACT

A relay device relays communication. The relay device includes: a receiving unit that receives communication data from a communication device; a storage unit that stores the communication data received by the receiving unit; and a processing unit that performs processing. A first period and a second period are alternately set. The processing unit changes the total number of the first periods and the second periods included in a next predetermined period each time a predetermined period including the first periods and the second periods passes. The processing unit determines whether or not the communication data is stored in the storage unit. When it is determined that the communication data is stored in the storage unit, the processing unit specifies a period to which a communication determination time at which the determination has been performed belongs, from the first period and the second period.

### CROSS-REFERENCE TO RELATED APPLICATIONS

This application is the U.S. national stage of PCT/JP2022/025038 filed Jun. 23, 2022, which claims priority of Japanese Patent Application No. 2021-116631 filed on Jul. 14, 2021, the contents of which are incorporated herein.

### TECHNICAL FIELD

The present disclosure relates to a relay device, a communication system, and a processing method.

### BACKGROUND

Japanese International Publication No. 2020/136843 discloses a communication system in which a communication device transmits data to another communication device through a relay device. The communication device transmits priority data that needs to reach another communication device in a short period. Upon receiving the priority data from the communication device, the relay device determines whether or not to transmit the received priority data. A permitted period during which transmission of priority data is permitted and a prohibited period during which transmission of priority data is prohibited are alternately set repeatedly. The relay device transmits the received priority data during the permitted period when the determination time at which whether or not to transmit the priority data is determined belongs to the permitted period.

If it is possible to determine the entire period from when a communication device gives an instruction to transmit data to the data determination time, for example, the communication device can adjust a point in time at which an instruction to transmit priority data is given so that the priority data determination time belongs to the permitted period. However, Japanese International Publication No. 2020/136843 does not disclose a configuration capable of determining the entire period.

The present disclosure has been made in view of such circumstances, and an object thereof is to provide a relay device, a communication system, and a processing method capable of determining the entire period from when an instruction to transmit data is given to the data determination time.

### SUMMARY

A relay device according to an aspect of the present disclosure is a relay device for relaying communication, and includes: a receiving unit that receives communication data from a communication device: a storage unit that stores the communication data received by the receiving unit; and a processing unit that performs processing. A first period and a second period are alternately set. The processing unit changes the total number of the first periods and the second periods included in a next predetermined period each time a predetermined period including the first periods and the second periods passes, determines whether or not the communication data is stored in the storage unit, and specifies a period to which a communication determination time at which the determination has been performed belongs, from the first period and the second period, when it is determined that the communication data is stored in the storage unit.

A communication system according to an aspect of the present disclosure includes: a communication device that transmits data; and a relay device that receives data from the communication device and transmits the received data. The communication device has a communication processing unit that performs processing. The communication processing unit gives an instruction to transmit communication data to the relay device. The relay device includes: a relay receiving unit that receives the communication data from the communication device; a relay storage unit that stores the communication data received by the relay receiving unit; and a relay processing unit that performs processing. A first period and a second period are alternately set. The relay processing unit changes the total number of the first periods and the second periods included in a next predetermined period each time a predetermined period including the first periods and the second periods passes, determines whether or not the communication data is stored in the relay storage unit, and specifies a period to which a communication determination time at which the determination has been performed belongs, from the first period and the second period, when it is determined that the communication data is stored in the relay storage unit.

A processing method according to an aspect of the present disclosure is a processing method of a relay device that relays communication and includes a receiving unit for receiving communication data from a communication device and a storage unit for storing the communication data received by the receiving unit. The processing method causes a computer to execute: a step of changing the total number of first periods and second periods, which are alternately set, included in a next predetermined period each time a predetermined period including the first periods and the second periods passes: a step of determining whether or not the communication data is stored in the storage unit; and a step of specifying a period to which a communication determination time at which the determination has been performed belongs, from the first period and the second period, when it is determined that the communication data is stored in the storage unit.

In addition, not only can the present disclosure be realized as a relay device including such characteristic processing units, but also the present disclosure can be realized as a processing method including such characteristic processes as steps or can be realized as a computer program causing a computer to execute such steps. In addition, the present disclosure can be realized as a semiconductor integrated circuit that realizes a part or the entirety of a relay device, or can be realized as a communication system including a relay device.

### Advantageous Effects

According to the above aspect, it is possible to determine the entire period from when an instruction to transmit data is given to the data determination time.

### BRIEF DESCRIPTION OF DRAWINGS

FIG. 1 is a block diagram showing the main configuration of a communication system according to a first embodiment.

FIG. 2 is an explanatory diagram of a relay method of a relay device.

FIG. 3 is an explanatory diagram of an operation performed within a transmission buffer.

FIG. 4 is an explanatory diagram of a relay frame determination method performed by a relay device.

FIG. 5 is a chart showing a relationship between a relay determination time and an operation for a relay frame.

FIG. 6 is an explanatory diagram of a communication frame determination method performed by a relay device.

FIG. 7 is a chart showing a relationship between a communication determination time and an operation for a communication frame.

FIG. 8 is a block diagram showing the main configuration of a relay device.

FIG. 9 is an explanatory diagram of the contents of pattern data.

FIG. 10 is a chart showing the contents of target data.

FIG. 11 is a block diagram showing the main configuration of in-vehicle equipment.

FIG. 12 is a flowchart showing the procedure of initial setting performed by a relay device and in-vehicle equipment.

FIG. 13 is a flowchart showing the procedure of initial setting performed by the relay device and the in-vehicle equipment.

FIG. 14 is a sequence diagram for explaining the outline of a method of determining the entire period of in-vehicle equipment.

FIG. 15 is an explanatory diagram of a method of specifying a belonging range.

FIG. 16 is an explanatory diagram of a method of determining an entire period when there are two ranges as belonging ranges.

FIG. 17 is a flowchart showing the procedure of period change processing corresponding to the communication queue of a transmission buffer.

FIG. 18 is a flowchart showing the procedure of communication frame relay processing of a transmission buffer.

FIG. 19 is a flowchart showing the procedure of period determination processing of in-vehicle equipment.

FIG. 20 is a flowchart showing the procedure of relay frame transmission processing of in-vehicle equipment.

FIG. 21 is an explanatory diagram of the contents of pattern data in a second embodiment.

FIG. 22 is a flowchart showing the procedure of period notification processing of a transmission buffer in a third embodiment.

FIG. 23 is a flowchart showing the procedure of period determination processing of in-vehicle equipment.

FIG. 24 is a flowchart showing the procedure of initial setting performed by a relay device and in-vehicle equipment in a fourth embodiment.

FIG. 25 is a sequence diagram for explaining the outline of a method of determining the entire period of in-vehicle equipment.

FIG. 26 is a flowchart showing the procedure of period change processing corresponding to the communication queue of a transmission buffer.

FIG. 27 is a flowchart showing the procedure of communication frame transmission processing of in-vehicle equipment.

FIG. 28 is a flowchart showing the procedure of period adjustment processing of a transmission buffer.

### DETAILED DESCRIPTION OF PREFERRED EMBODIMENTS

First, embodiments of the present disclosure will be listed and described. At least some of the embodiments described below may be arbitrarily combined.

A relay device according to an aspect of the present disclosure is a relay device for relaying communication, and includes: a receiving unit that receives communication data from a communication device: a storage unit that stores the communication data received by the receiving unit; and a processing unit that performs processing. A first period and a second period are alternately set. The processing unit changes the total number of the first periods and the second periods included in a next predetermined period each time a predetermined period including the first periods and the second periods passes, determines whether or not the communication data is stored in the storage unit, and specifies a period to which a communication determination time at which the determination has been performed belongs, from the first period and the second period, when it is determined that the communication data is stored in the storage unit.

(2) In the relay device according to an aspect of the present disclosure, the processing unit changes the total number in each predetermined period so that the total numbers in a plurality of consecutive predetermined periods are different, and changes a position of a boundary between the first period and the second period in each predetermined period so that the positions of the boundaries in the plurality of predetermined periods are different.

(3) In the relay device according to an aspect of the present disclosure, the processing unit changes the total number in each predetermined period so that the total numbers in a plurality of consecutive predetermined periods are different, and repeats the plurality of predetermined periods a plurality of times.

(4) In the relay device according to an aspect of the present disclosure, the receiving unit receives the communication data from the communication device each time the predetermined period passes. The processing unit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

(5) In the relay device according to an aspect of the present disclosure, the receiving unit receives relay data for relaying. The received relay data is stored in the storage unit. A permitted period during which transmission of the relay data is permitted and a prohibited period during which transmission of the relay data is prohibited are alternately set. The processing unit determines whether or not the relay data is stored in the storage unit, specifies a period to which a relay determination time at which the determination has been performed belongs, from the permitted period and the prohibited period, when it is determined that the relay data is stored in the storage unit, gives an instruction to transmit the relay data when the specified period is the permitted period, and adjusts a starting time or length of the permitted period based on the determined entire period.

(6) A communication system according to an aspect of the present disclosure includes: a communication device that transmits data; and a relay device that receives data from the communication device and transmits the received data. The communication device has a communication processing unit that performs processing. The communication processing unit gives an instruction to transmit communication data to the relay device. The relay device includes: a relay receiving unit that receives the communication data from the communication device: a relay storage unit that stores the communication data received by the relay receiving unit; and a relay processing unit that performs processing. A first period and a second period are alternately set. The relay processing unit changes the total number of the first periods and the second periods included in a next predetermined period each time a predetermined period including the first periods and the second periods passes, determines whether or not the communication data is stored in the relay storage unit, and specifies a period to which a communication determination time at which the determination has been performed belongs, from the first period and the second period, when it is determined that the communication data is stored in the relay storage unit.

(7) In the communication system according to an aspect of the present disclosure, the communication processing unit gives an instruction to transmit the communication data to the relay receiving unit each time the predetermined period passes. The relay processing unit changes the total number in each predetermined period so that the total numbers in a plurality of consecutive predetermined periods are different. The communication processing unit specifies a belonging range to which the communication determination time belongs in the predetermined period, based on a plurality of specifying results specified by the relay processing unit regarding a period, when the plurality of predetermined periods pass, and determines an entire period from when the instruction to transmit the communication data is given to the communication determination time based on the specified belonging range.

(8) In the communication system according to an aspect of the present disclosure, the communication processing unit gives an instruction to transmit relay data for relaying to the relay receiving unit. The relay data received by the relay receiving unit is stored in the relay storage unit. A permitted period during which transmission of the relay data is permitted and a prohibited period during which transmission of the relay data is prohibited are alternately set. The relay processing unit determines whether or not the relay data is stored in the relay storage unit, specifies a period to which a relay determination time at which the determination has been performed belongs, from the permitted period and the prohibited period, when it is determined that the relay data is stored in the relay storage unit, and gives an instruction to transmit the relay data when the specified period is the permitted period. The communication processing unit determines a transmission instruction time at which an instruction to transmit the relay data is given based on the determined entire period.

(9) In the communication system according to an aspect of the present disclosure, the relay processing unit gives an instruction to transmit the communication data received by the relay receiving unit to the communication device when the specified period is the first period, and discards the communication data received by the relay receiving unit when it is determined that the specified period is the second period. The communication processing unit specifies a belonging range to which the communication determination time belongs in the predetermined period, based on a plurality of results of receiving the communication data, when the plurality of predetermined periods pass.

(10) A processing method according to an aspect of the present disclosure is a processing method of a relay device that relays communication and includes a receiving unit for receiving communication data from a communication device and a storage unit for storing the communication data received by the receiving unit. The processing method causes a computer to execute: a step of changing the total number of first periods and second periods, which are alternately set, included in a next predetermined period each time a predetermined period including the first periods and the second periods passes: a step of determining whether or not the communication data is stored in the storage unit; and a step of specifying a period to which a communication determination time at which the determination has been performed belongs, from the first period and the second period, when it is determined that the communication data is stored in the storage unit.

In the above aspect, for example, the communication device gives an instruction to transmit the communication data each time the predetermined period passes. The relay device changes the total number of the first periods and the second periods included in the next predetermined period each time a predetermined period passes. The relay device specifies a period to which the communication determination time of the communication data belongs. The communication device or the relay device can specify a belonging range to which the communication determination time of the communication data belongs in the predetermined period, based on a plurality of specifying results regarding the communication data. Based on the specified belonging range, the communication device or the relay device can determine the entire period from when the instruction to transmit the communication data is given from the communication device to the communication determination time.

In the above aspect, for example, the communication device gives an instruction to transmit the communication data each time the predetermined period passes. For a plurality of consecutive predetermined periods, the total numbers of the first periods and the second periods are different. After the plurality of consecutive predetermined periods have passed, the communication device or the relay device can specify the belonging range to which the communication determination time of the communication data belongs in the predetermined period, based on a plurality of specifying results regarding the communication data.

When the boundaries of a plurality of consecutive predetermined periods match each other, if a plurality of communication determination times change in the vicinity of the plurality of boundaries that match each other, the period to which the communication determination times belong is not fixed to one period in each predetermined period. Therefore, the communication device or the relay device cannot accurately specify the belonging range. However, the positions of the boundaries in the plurality of consecutive predetermined periods are different. Therefore, the communication device or the relay device can accurately specify the belonging range even if the communication determination time changes.

In the above aspect, for example, the communication device gives an instruction to transmit the communication data each time the predetermined period passes. Each time the plurality of consecutive predetermined periods pass, the communication device or the relay device specifies the belonging range of the communication determination time based on a plurality of specifying results regarding the communication data. The relay device repeats a plurality of predetermined periods a plurality of times. Therefore, when the communication determination time changes, the communication device or the relay device can determine the entire period considering the change based on the plurality of specified belonging ranges.

In the above aspect, for example, the communication device gives an instruction to transmit the communication data each time the predetermined period passes. When the predetermined period passes, the relay device specifies the belonging range of the communication determination time based on a plurality of specifying results regarding the communication data. The relay device determines the entire period based on the specified belonging range.

In the above aspect, the relay device adjusts the start time or length of the permitted period based on the determined entire period, for example, so that the relay determination time of the relay data belongs to the permitted period.

In the above aspect, for example, the communication device gives an instruction to transmit the communication data each time the predetermined period passes. When the predetermined period passes, the communication device specifies the belonging range of the communication determination time based on a plurality of specifying results regarding the communication data. The communication device determines the entire period based on the specified belonging range.

In the above aspect, the communication device determines the transmission instruction time at which an instruction to transmit the relay data to the relay device is given, based on the determined entire period, for example, so that the relay determination time of the relay data belongs to the permitted period.

In the above aspect, the result of receiving the communication data indicates a result of specifying the communication data regarding a period. The communication device specifies the belonging range of the communication determination time based on the reception result, and determines the entire period based on the specified belonging range.

Specific examples of communication systems according to embodiments of the present disclosure will be described below with reference to the diagrams. In addition, the present disclosure is not limited to these examples but is defined by the claims, and is intended to include all modifications within the meaning and scope equivalent to the claims.

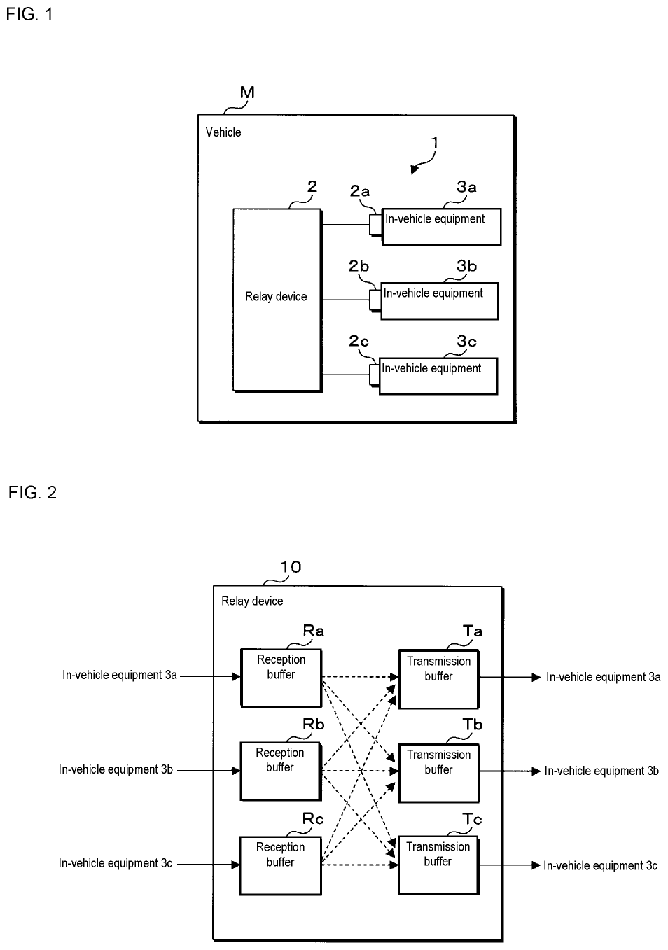

FIG. 1 is a block diagram showing the main configuration of a communication system 1 according to a first embodiment. The communication system 1 is mounted in a vehicle M. The communication system 1 includes a relay device 2 and three pieces of in-vehicle equipment 3a, 3b, and 3c. Each of the pieces of in-vehicle equipment 3a, 3b, and 3c is, for example, an ECU (Electronic Control Unit). Three connectors 2a, 2b, and 2c are independently connected to the relay device 2. The pieces of in-vehicle equipment 3a, 3b, and 3c are detachably connected to the connectors 2a, 2b, and 2c, respectively.

Each of the pieces of in-vehicle equipment 3a, 3b, and 3c functions as a communication device. Each of the pieces of in-vehicle equipment 3a, 3b, and 3c transmits and receives a relay frame for relay. The relay frame is data having a plurality of bits, and corresponds to relay data. The relay device 2 receives a relay frame from each of the pieces of in-vehicle equipment 3a, 3b, and 3c. When a relay frame is received from the in-vehicle equipment 3a, the relay device 2 transmits the received relay frame to one of the pieces of in-vehicle equipment 3b and 3c. Similarly, when a relay frame is received from the in-vehicle equipment 3b, the relay device 2 transmits the received relay frame to one of the pieces of in-vehicle equipment 3a and 3c. When a relay frame is received from the in-vehicle equipment 3c, the relay device 2 transmits the received relay frame to one of the pieces of in-vehicle equipment 3a and 3b. As described above, the relay device 2 relays communication between two of the pieces of in-vehicle equipment 3a, 3b, and 3c.

Each of the pieces of in-vehicle equipment 3a, 3b, and 3c transmits a relay frame including sensor data, instruction data, and the like to the relay device 2. The sensor data indicates a detection value detected by a sensor. The vehicle M has, for example, a reception unit that receives an instruction from an occupant. The instruction data indicates, for example, an instruction received by the reception unit. The instruction data indicates, for example, an instruction to lock or unlock the door. When a relay frame is received from the relay device 2, each of the pieces of in-vehicle equipment 3a, 3b, and 3c performs an operation based on the received relay frame.

Each of the pieces of in-vehicle equipment 3a, 3b, and 3c transmits and receives a communication frame to determine an entire period described later. The communication frame is data having a plurality of bits, and corresponds to communication data. The relay device 2 receives a communication frame from each of the pieces of in-vehicle equipment 3a, 3b, and 3c. When a communication frame is received from the in-vehicle equipment 3a, the relay device 2 transmits the received communication frame to the in-vehicle equipment 3a. Similarly, when a communication frame is received from the in-vehicle equipment 3b, the relay device 2 transmits the received communication frame to the in-vehicle equipment 3b. When a communication frame is received from the in-vehicle equipment 3c, the relay device 2 transmits the received communication frame to the in-vehicle equipment 3c.

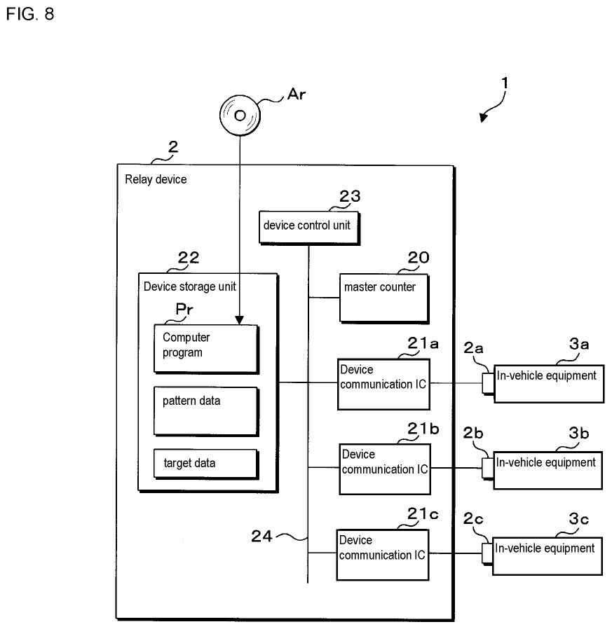

FIG. 2 is an explanatory diagram of a relay method of the relay device 2. The relay device 2 has a device storage unit 22 (see FIG. 8). In the device storage unit 22, as shown in FIG. 2, three reception buffers Ra, Rb, and Rc and three transmission buffers Ta, Tb, and Tc are provided as storage areas. The relay device 2 writes the relay frames received from the pieces of in-vehicle equipment 3a, 3b, and 3c into the reception buffers Ra, Rb, and Rc, respectively. Similarly, the relay device 2 writes the communication frames received from the pieces of in-vehicle equipment 3a, 3b, and 3c into the reception buffers Ra, Rb, and Rc, respectively.

Relay frames whose transmission destinations are the pieces of in-vehicle equipment 3a, 3b, and 3c are written in the transmission buffers Ta, Tb, and Tc, respectively. Similarly, communication frames whose transmission destinations are the pieces of in-vehicle equipment 3a, 3b, and 3c are written in the transmission buffers Ta, Tb, and Tc, respectively. Each of the relay frame and the communication frame indicates a transmission destination.

The relay device 2 moves relay frames whose transmission destination is the in-vehicle equipment 3a, among the relay frames stored in the reception buffers Rb and Rc, to the transmission buffer Ta. Similarly, the relay device 2 moves relay frames whose transmission destination is the in-vehicle equipment 3b, among the relay frames stored in the reception buffers Ra and Rc, to the transmission buffer Tb. The relay device 2 moves relay frames whose transmission destination is the in-vehicle equipment 3c, among the relay frames stored in the reception buffers Ra and Rb, to the transmission buffer Tc.

The transmission destinations of the communication frames stored in the reception buffers Ra, Rb, and Rc are the pieces of in-vehicle equipment 3a, 3b, and 3c, respectively. Therefore, the relay device 2 moves the communication frames stored in the reception buffers Ra, Rb, and Rc to the transmission buffers Ta, Tb, and Tc, respectively.

The relay device 2 transmits the relay frame and the communication frame stored in the transmission buffer Ta to the in-vehicle equipment 3a. Similarly, the relay device 2 transmits the relay frame and the communication frame stored in the transmission buffer Tb to the in-vehicle equipment 3b. The relay device 2 transmits the relay frame and the communication frame stored in the transmission buffer Tc to the in-vehicle equipment 3c.

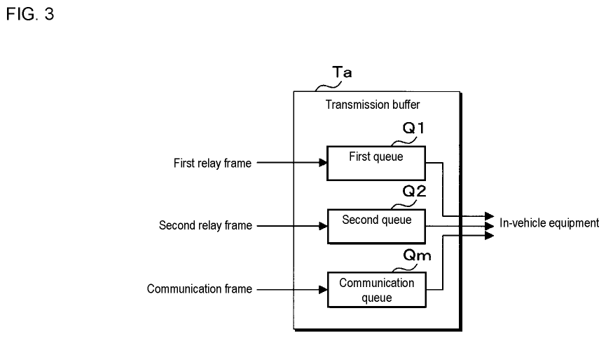

FIG. 3 is an explanatory diagram of an operation performed in the transmission buffer Ta. In each of the transmission buffers Ta, Tb, and Tc, a first queue Q1, a second queue Q2, and a communication queue Qm are provided as storage areas. Each of the pieces of in-vehicle equipment 3a, 3b, and 3c transmits two types of relay frames. The two types of relay frames are hereinafter referred to as a first relay frame and a second relay frame.

The relay device 2 writes the first relay frame whose transmission destination is the in-vehicle equipment 3a to the first queue Q1 in the transmission buffer Ta. In addition, the relay device 2 writes the second relay frame whose transmission destination is the in-vehicle equipment 3a to the second queue Q2 in the transmission buffer Tb. The relay device 2 writes the communication frame whose transmission destination is the in-vehicle equipment 3a to the communication queue Qm.

The writing performed by the relay device 2 in each of the transmission buffers Tb and Tc is the same as the writing performed by the relay device 2 in the transmission buffer Ta. The relay device 2 writes the first relay frame, the second relay frame, and the communication frame whose transmission destination is the in-vehicle equipment 3b to the first queue Q1, the second queue Q2, and the communication queue Qm of the transmission buffer Tb, respectively. The relay device 2 writes the first relay frame, the second relay frame, and the communication frame whose transmission destination is the in-vehicle equipment 3c to the first queue Q1, the second queue Q2, and the communication queue Qm of the transmission buffer Tc, respectively.

In each of the transmission buffers Ta, Tb, and Tc, when the first relay frame is stored in the first queue Q1, the relay device 2 transmits or discards the first relay frame stored in the first queue Q1. After transmitting the first relay frame, the relay device 2 discards the transmitted first relay frame. The relay frame is discarded by deleting the relay frame from the device storage unit 22.

Similarly, in each of the transmission buffers Ta, Tb, and Tc, when the second relay frame is stored in the second queue Q2, the relay device 2 transmits or discards the second relay frame stored in the second queue Q2. After transmitting the second relay frame, the relay device 2 discards the transmitted second relay frame. In each of the transmission buffers Ta, Tb, and Tc, when a communication frame is stored in the communication queue Qm, the relay device 2 transmits or discards the communication frame stored in the communication queue Qm. After transmitting the communication frame, the relay device 2 discards the transmitted communication frame. The communication frame is discarded by deleting the communication frame from the device storage unit 22.

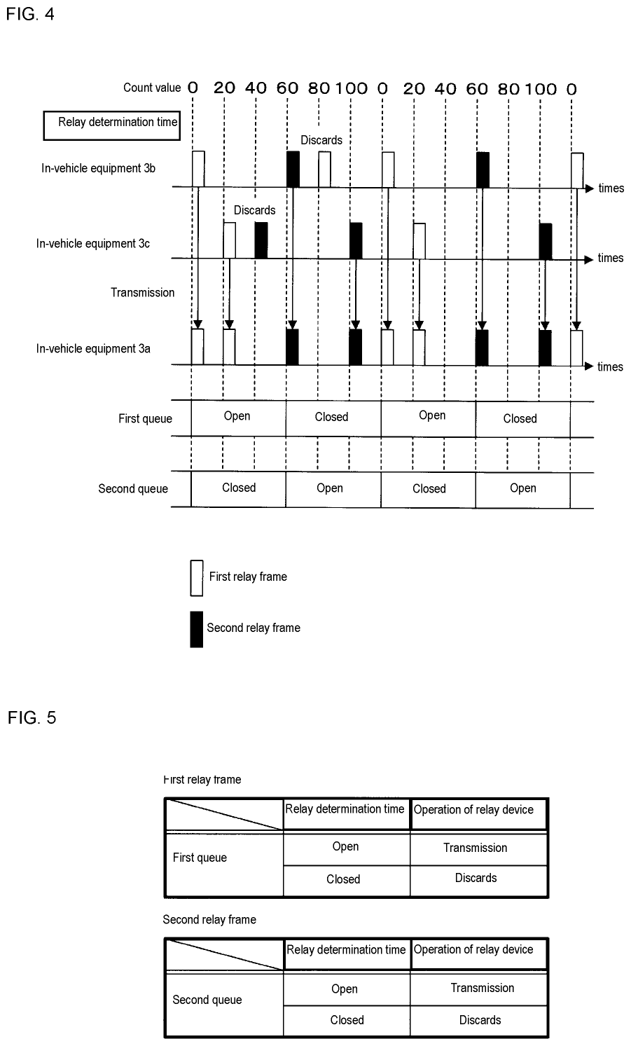

FIG. 4 is an explanatory diagram of a relay frame determination method performed by the relay device 2. The relay device 2 has a master counter 20 (see FIG. 8). A count value is stored in the master counter 20. The count value of the master counter 20 is shown in FIG. 4. A certain count number is determined in advance. The count number is 2 or more. The master counter 20 increments the count value by 1 each time a predetermined period passes. When the count value (count number) is −1, the master counter 20 resets the count value to zero after a predetermined period passes. In the example of FIG. 4, the count number is 120. One cycle is expressed by (count number)·(predetermined period). “·” represents a product.

For each of the first queue Q1 and the second queue Q2, an open period and a close period are alternately set repeatedly. In the example of FIG. 4, for the first queue Q1, a period during which the count value is a value within the range of 0 to 74 is the open period. A period during which the count value is a value within the range of 75 to 119 is the close period. For the second queue Q2, a period during which the count value is a value within the range of 0 to 74 is the close period. A period during which the count value is a value within the range of 75 to 119 is the open period.

The relay device 2 determines whether or not the first relay frame is stored in the first queue Q1. When it is determined that the first relay frame is stored in the first queue Q1, the relay device 2 specifies a period, to which the relay determination time at which the determination has been performed belongs, from the open period and the close period. Similarly, the relay device 2 determines whether or not the second relay frame is stored in the second queue Q2. When it is determined that the second relay frame is stored in the second queue Q2, the relay device 2 specifies a period, to which the relay determination time at which the determination has been performed belongs, from the open period and the close period.

FIG. 5 is a chart showing a relationship between a relay determination time and an operation for a relay frame. As shown in FIG. 5, for the first relay frame, when the period of the first queue Q1 to which the relay determination time belongs is an open period, the relay device 2 transmits the first relay frame. The first relay frames stored in the transmission buffers Ta, Tb, and Tc are transmitted to the pieces of in-vehicle equipment 3a, 3b, and 3c, respectively. For the first relay frame, when the period to which the relay determination time belongs is a close period, the relay device 2 discards the first relay frame.

Similarly, for the second relay frame, when the period of the second queue Q2 to which the relay determination time belongs is an open period, the relay device 2 transmits the second relay frame. The second relay frames stored in the transmission buffers Ta, Tb, and Tc are transmitted to the pieces of in-vehicle equipment 3a, 3b, and 3c, respectively. For the second relay frame, when the period to which the relay determination time belongs is a close period, the relay device 2 discards the second relay frame.

The open period of each of the first queue Q1 and the second queue Q2 corresponds to a permitted period during which relay frame transmission is permitted. The close period of each of the first queue Q1 and the second queue Q2 corresponds to a prohibited period during which relay frame transmission is prohibited.

FIG. 4 shows a method of determining the first relay frame and the second relay frame stored in the transmission buffer Ta. In the first row of FIG. 4, the relay determination times of the first relay frame and the second relay frame transmitted from the in-vehicle equipment 3b to the relay device 2 are shown. In the second row of FIG. 4, the relay determination times of the first relay frame and the second relay frame transmitted from the in-vehicle equipment 3c to the relay device 2 are shown. In the third row of FIG. 4, the first relay frame and the second relay frame transmitted from the relay device 2 to the in-vehicle equipment 3a are shown.

As shown in FIG. 4, among a plurality of first relay frames whose transmission source is one of the pieces of in-vehicle equipment 3b and 3c, the first relay frame whose relay determination time belongs to the open period of the first queue Q1 is transmitted to the in-vehicle equipment 3a by the relay device 2.

Among a plurality of first relay frames whose transmission source is one of the pieces of in-vehicle equipment 3b and 3c, the first relay frame whose relay determination time belongs to the close period of the first queue Q1 is discarded by the relay device 2.

Similarly, among a plurality of second relay frames whose transmission source is one of the pieces of in-vehicle equipment 3b and 3c, the second relay frame whose relay determination time belongs to the open period of the second queue Q2 is transmitted to the in-vehicle equipment 3a by the relay device 2. Among a plurality of second relay frames whose transmission source is one of the pieces of in-vehicle equipment 3b and 3c, the second relay frame whose relay determination time belongs to the close period of the second queue Q2 is discarded by the relay device 2.

The relay device 2 transmits and discards relay frames according to the IEEE802.1Qbv and IEEE802.1Qci standards, as described above. IEEE is a registered trademark, and is an abbreviation for Institute of Electrical and Electronics Engineers.

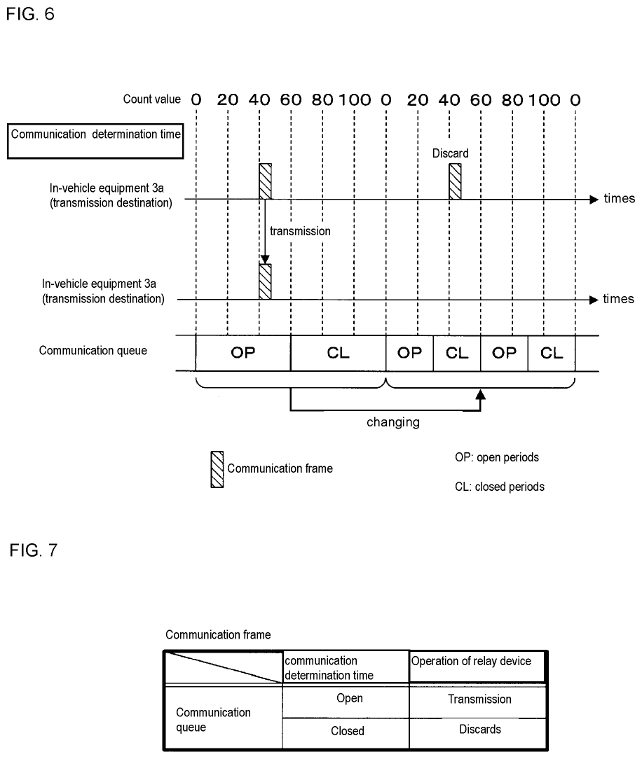

FIG. 6 is an explanatory diagram of a communication frame determination method performed by the relay device 2. For the communication queue Qm as well, an open period and a close period are alternately set repeatedly. One cycle includes an open period and a close period. The open period and close period of the communication queue Qm correspond to the first period and the second period, respectively. One cycle corresponds to a predetermined period. The relay device 2 determines whether or not a communication frame is stored in the communication queue Qm. When it is determined that a communication frame is stored in the communication queue Qm, the relay device 2 specifies a period, to which the communication determination time at which the determination has been performed belongs, from the open period and the close period.

FIG. 7 is a chart showing a relationship between a communication determination time and an operation for a communication frame. As shown in FIG. 6, for the communication frame, when the period to which the communication determination time belongs is an open period, the relay device 2 transmits the communication frame. The communication frames stored in the transmission buffers Ta, Tb, and Tc are transmitted to the pieces of in-vehicle equipment 3a, 3b, and 3c, respectively. For the communication frame, when the period to which the communication determination time belongs is a close period, the relay device 2 discards the communication frame.

FIG. 6 shows a method of determining communication frames stored in the transmission buffer Ta. In the first row of FIG. 6, the communication determination time of the communication frame transmitted from the in-vehicle equipment 3a to the relay device 2 is shown. In the second row of FIG. 6, the communication frame transmitted from the relay device 2 to the in-vehicle equipment 3a is shown. As shown in FIG. 6, a communication frame whose communication determination time belongs to the open period of the communication queue Qm is transmitted to the in-vehicle equipment 3a by the relay device 2. A communication frame whose communication determination time belongs to the close period of the communication queue Qm is discarded by the relay device 2.

The relay device 2 transmits and discards communication frames according to the IEEE802.1Qbv and IEEE802.1Qci standards, as described above.

As shown in FIG. 6, the relay device 2 can change the total number of open periods and close periods included in one cycle each time one cycle passes. In the example of FIG. 6, the relay device 2 changes the total number of open periods and close periods included in one cycle from two to four. The in-vehicle equipment 3a repeatedly gives an instruction to transmit the communication frame when the count value is zero.

The relay device 2 specifies, for each of K cycles, a period to which the communication determination time for the communication frame belongs. K is an integer of 2 or more. Based on the K specifying results regarding the period, the in-vehicle equipment 3a specifies a belonging range to which the communication determination time belongs in one cycle. Based on the specified belonging range, the in-vehicle equipment 3a determines the entire period from when an instruction to transmit the communication frame is given from the in-vehicle equipment 3a to the communication determination time. Based on the determined entire period, the in-vehicle equipment 3a gives an instruction to transmit the first relay frame and the second relay frame so that the relay determination time belongs to the open period.

Similarly, each of the pieces of in-vehicle equipment 3b and 3c repeatedly gives an instruction to transmit the communication frame when the count value is zero. Each of the pieces of in-vehicle equipment 3b and 3c specifies a belonging range, similarly to the in-vehicle equipment 3a. Each of the pieces of in-vehicle equipment 3b and 3c determines the entire periods of the pieces of in-vehicle equipment 3b and 3c, similarly to the in-vehicle equipment 3a. Each of the pieces of in-vehicle equipment 3b and 3c gives an instruction to transmit the first relay frame and the second relay frame, similarly to the in-vehicle equipment 3a.

### Configuration of Relay Device

FIG. 8 is a block diagram showing the main configuration of the relay device 2. The relay device 2 has the master counter 20 and the device storage unit 22 as described above. The relay device 2 further has three device communication ICs 21a, 21b, and 21c and a device control unit 23. IC is an abbreviation for Integrated Circuit. The master counter 20, the device communication ICs 21a, 21b, and 21c, the device storage unit 22, and the device control unit 23 are connected to a device bus 24. The device communication ICs 21a, 21b, and 21c are connected to connectors 2a, 2b, and 2c, respectively. As described above, the pieces of in-vehicle equipment 3a, 3b, and 3c are connected to the connectors 2a, 2b, and 2c, respectively.

The device communication ICs 21a, 21b, and 21c receive relay frames, communication frames, request data, start data, and the like from the pieces of in-vehicle equipment 3a, 3b, and 3c, respectively. Each of the device communication ICs 21a, 21b, and 21c functions as a receiving unit and a relay receiving unit. The device communication ICs 21a, 21b, and 21c transmit relay frames, communication frames, response data, count data, pattern data, target data, and the like to the pieces of in-vehicle equipment 3a, 3b, and 3c according to instructions from the device control unit 23, respectively.

The request data is data for making a request for transmission of response data. The start data indicates the start of transmission of the communication frame. The response data is data transmitted when request data is received. The count data indicates the count value of the master counter 20. The pattern data indicates the arrangement of open periods and close periods for each of K cycles. The target data indicates a target time. The target time is a point in time at which it is determined whether or not the relay frame is stored.

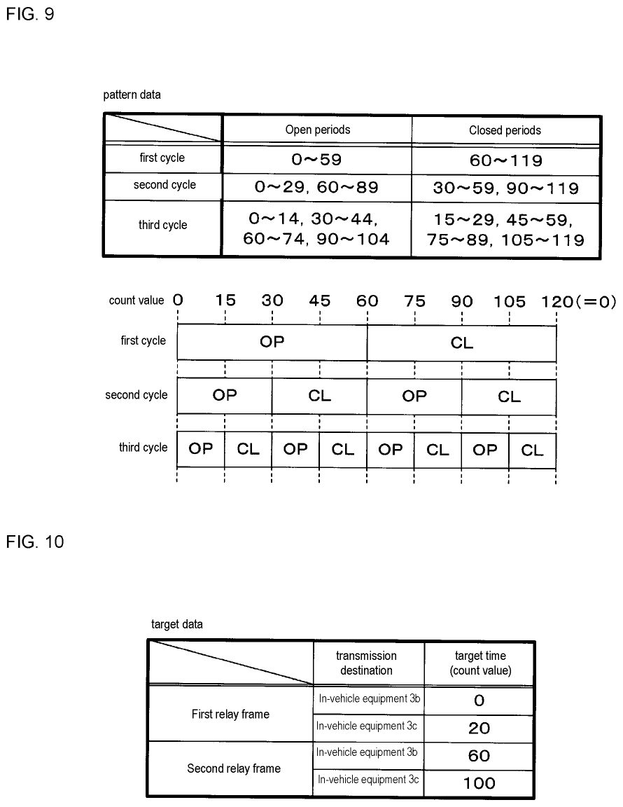

FIG. 9 is an explanatory diagram of the contents of pattern data. FIG. 9 shows an example where the count number is 120 and K is 3. In the pattern data, for each of the first, second, and third cycles, the arrangement of open periods and close periods is indicated by the count value of the master counter 20. For example, the open period of the first cycle is a period during which the count value is a value within the range of 0 to 59. The close period of the first cycle is a period during which the count value is a value within the range of 60 to 119. In the example of FIG. 9, for each of K cycles, the number of open periods is the same as the number of close periods.

The total number of open periods and close periods included in the i-th cycle is 2 to the i power. Here, i is any natural number equal to or less than K, and may be any of 1, 2, . . . , K. In the example of FIG. 9, the lengths of a plurality of periods included in each cycle are the same. In addition, the length of each of a plurality of periods included in each cycle may be different from the length of at least one of the other periods.

The relay device 2 changes the total number, the position of the boundary, and the like according to the pattern data for the open periods and the close periods of the communication queue Qm over the first to Kth cycles. The boundary to be changed is the boundary between the open period and the close period. The relay device 2 changes the total number of open periods and close periods of the communication queue Qm included in the next cycle each time one cycle elapses. The relay device 2 changes the total number of open periods and close periods included in each cycle so that the total numbers in the consecutive K cycles are different.

FIG. 10 is a chart showing the contents of target data. As described above, the target data indicates the target time of the relay frame. The target time is represented by the count value of the master counter 20. FIG. 10 shows target data used by the in-vehicle equipment 3a. The in-vehicle equipment 3a transmits the first relay frame and the second relay frame to the device communication IC 21a so that the relay determination time becomes the target time.

In the example of FIG. 10, the in-vehicle equipment 3a transmits the first relay frame whose transmission destination is the in-vehicle equipment 3b so that the point in time at which the count value of the master counter 20 is zero becomes the relay determination time. The in-vehicle equipment 3a transmits the first relay frame whose transmission destination is the in-vehicle equipment 3c so that the point in time at which the count value of the master counter 20 is 20 becomes the relay determination time. Similarly, the in-vehicle equipment 3a transmits the second relay frame whose transmission destination is the in-vehicle equipment 3b so that the point in time at which the count value of the master counter 20 is 60 becomes the relay determination time. The in-vehicle equipment 3a transmits the second relay frame whose transmission destination is the in-vehicle equipment 3c so that the point in time at which the count value of the master counter 20 is 100 becomes the relay determination time.

The contents of the target data used by each of the pieces of in-vehicle equipment 3b and 3c are the same as the contents of the target data used by the in-vehicle equipment 3a. The target data used by the in-vehicle equipment 3b indicates the contents of the relay frame whose transmission destination is one of the pieces of in-vehicle equipment 3a and 3c. The target data used by the in-vehicle equipment 3c indicates the contents of the relay frame whose transmission destination is one of the pieces of in-vehicle equipment 3a and 3b. It is preferable that the target times of a plurality of first relay frames having the same transmission destination and different transmission sources are different. Similarly, it is preferable that the target times of a plurality of second relay frames having the same transmission destination and different transmission sources are different.

Pattern data and three pieces of target data are stored in the device storage unit 22 shown in FIG. 8. The device control unit 23 has a processing element that performs processing, for example, a CPU (Central Processing Unit). The device control unit 23 functions as a processing unit and a relay processing unit. A computer program Pr is further stored in the device storage unit 22. The computer program Pr is a program product. By executing the computer program Pr, the processing element (computer) of the device control unit 23 performs three data transmission processes, three period change processes, data movement processing, communication frame relay processes of the transmission buffers Ta, Tb, and Tc, first and second relay processes of the transmission buffer Ta, first and second relay processes of the transmission buffer Tb, and first and second relay processes of the transmission buffer Tc.

Each of the three data transmission processes is a process of transmitting response data, count data, pattern data, target data, and the like to the pieces of in-vehicle equipment 3a, 3b, and 3c. The period change process is a process of changing the total number, the position of the boundary, and the like according to the pattern data for the open periods and the close periods of the communication queue Qm over the first to Kth cycles. Each of the three period change processes corresponds to the communication queue Qm of the transmission buffers Ta, Tb, and Tc. The data movement processing is processing for moving the relay frame or the communication frame from one of the reception buffers Ra, Rb, and Rc to at least one of the transmission buffers Ta, Tb, and Tc. The communication frame relay processing is processing for relaying the communication frame. The first relay processing is processing for relaying the first relay frame. The second relay processing is processing for relaying the second relay frame.

In addition, the computer program Pr may be provided to the relay device 2 by using a non-transitory storage medium Ar in which the computer program Pr is stored in a readable manner. The storage medium Ar is, for example, a portable memory. Examples of the portable memory include a CD-ROM, a USB (Universal Serial Bus) memory, an SD card, a micro SD card, and a compact flash (registered trademark). If the storage medium Ar is a portable memory, the processing element of the device control unit 23 may read the computer program Pr from the storage medium Ar by using a reader (not shown). The read computer program Pr is written in the device storage unit 22. In addition, the computer program Pr may be provided to the relay device 2 by a communication unit (not shown) of the relay device 2 communicating with an external device. In this case, the processing element of the device control unit 23 acquires the computer program Pr through the communication unit. The acquired computer program Pr is written in the device storage unit 22.

In addition, the number of processing elements included in the device control unit 23 is not limited to one, and may be two or more. When the device control unit 23 has a plurality of processing elements, the plurality of processing elements may cooperate to execute the above-described processes such as the three data transmission processes and the three period change processes.

The device storage unit 22 is formed by, for example, a non-volatile memory and a volatile memory. In this case, the non-volatile memory of the device storage unit 22 stores, for example, the computer program Pr, pattern data, target data, and the like. For example, the three reception buffers Ra, Rb, and Rc and the three transmission buffers Ta, Tb, and Tc are provided in the storage area of the volatile memory of the device storage unit 22.

### Configurations of Pieces of In-Vehicle Equipment

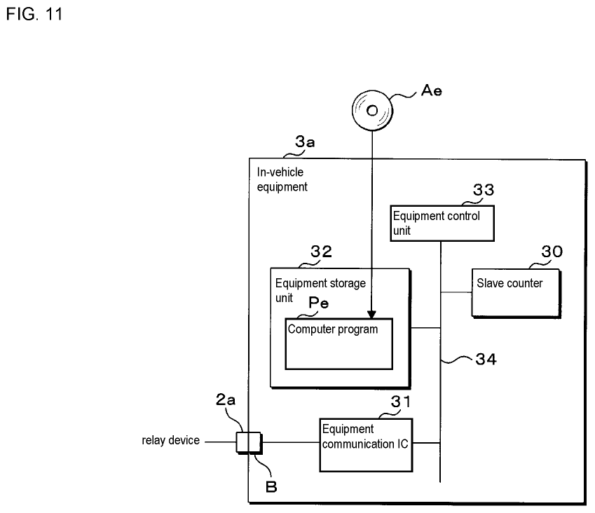

FIG. 11 is a block diagram showing the main configuration of the in-vehicle equipment 3a. The in-vehicle equipment 3a has a slave counter 30, an equipment communication IC 31, an equipment storage unit 32, and an equipment control unit 33. These are connected to an equipment bus 34. The equipment communication IC 31 is further connected to an equipment connector B. The equipment connector B of the in-vehicle equipment 3a is detachably connected to the connector 2a.

A count value is stored in the slave counter 30. Similar to the master counter 20, the slave counter 30 increments the count value by 1 each time a predetermined period passes. The predetermined period and the count number of the slave counter 30 are the same as the predetermined period and the count number of the master counter 20. When the count value (count number) is −1, the slave counter 30 resets the count value to zero after the predetermined period passes. The equipment control unit 33 synchronizes the count value of the slave counter 30 with the count value of the master counter 20.

The equipment communication IC 31 receives relay frames, communication frames, response data, count data, pattern data, target data, and the like from the device communication IC 21a of the relay device 2. The equipment communication IC 31 transmits relay frames, communication frames, request data, start data, and the like according to instructions from the equipment control unit 33.

A computer program Pe is stored in the equipment storage unit 32. The computer program Pe is a program product. The equipment control unit 33 includes a processing element that performs processing, for example, a CPU. The equipment control unit 33 functions as a communication processing unit. The processing element (computer) of the equipment control unit 33 performs adjustment processing, period determination processing, writing processing, relay frame transmission processing, and the like by executing the computer program Pe.

In the adjustment processing, the equipment control unit 33 adjusts the count value of the slave counter 30. In the adjustment processing, the equipment control unit 33 also writes pattern data, target data, and the like into the equipment storage unit 32. The period determination processing is processing for determining the entire period. The writing processing is processing for writing the relay frame into the equipment storage unit 32. The relay frame transmission processing is processing for transmitting the relay frame to the relay device 2.

In addition, the computer program Pe may be provided to the in-vehicle equipment 3a by using a non-transitory storage medium Ae in which the computer program Pe is stored in a readable manner. The storage medium Ae is, for example, a portable memory. If the storage medium Ae is a portable memory, the processing element of the equipment control unit 33 may read the computer program Pe from the storage medium Ae by using a reader (not shown). The read computer program Pe is written in the equipment storage unit 32. In addition, the computer program Pe may be provided to the in-vehicle equipment 3a by a communication unit (not shown) of the in-vehicle equipment 3a communicating with an external device. In this case, the processing element of the equipment control unit 33 acquires the computer program Pe through the communication unit. The acquired computer program Pe is written in the equipment storage unit 32.

In addition, the number of processing elements included in the equipment control unit 33 is not limited to one, and may be two or more. When the equipment control unit 33 has a plurality of processing elements, the plurality of processing elements may cooperate with each other to perform adjustment processing, period determination processing, writing processing, relay frame transmission processing, and the like.

The equipment storage unit 32 is formed by, for example, a non-volatile memory and a volatile memory. In this case, the non-volatile memory of the equipment storage unit 32 stores, for example, the computer program Pe, target data, and the like.

The pieces of in-vehicle equipment 3b and 3c are configured similarly to the in-vehicle equipment 3a. The connector 2a corresponds to the connectors 2b and 2c. The device communication IC 21a corresponds to the device communication ICs 21b and 21c.

### Initial Setting Performed by Relay Device

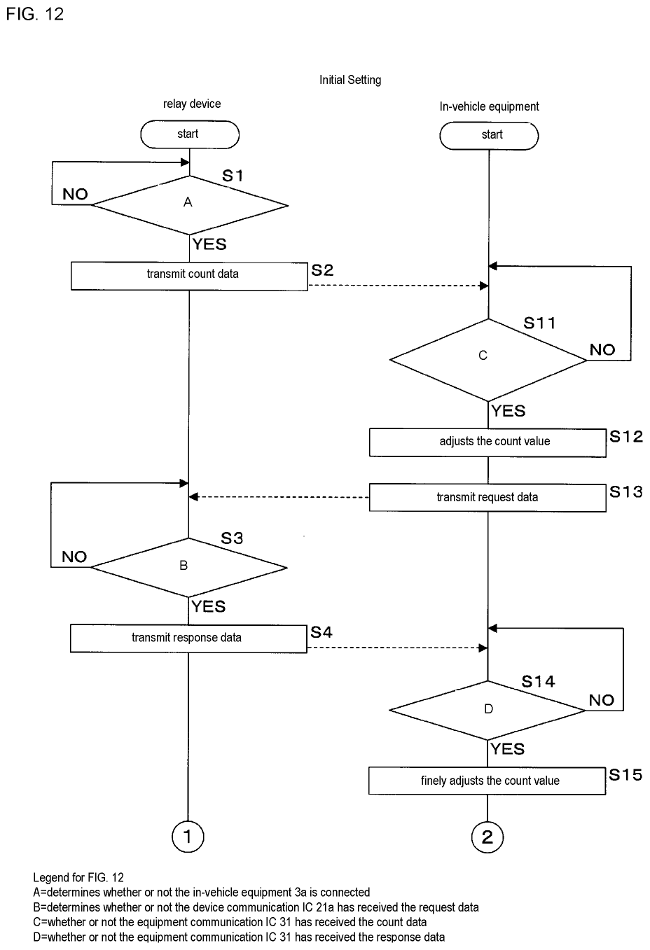

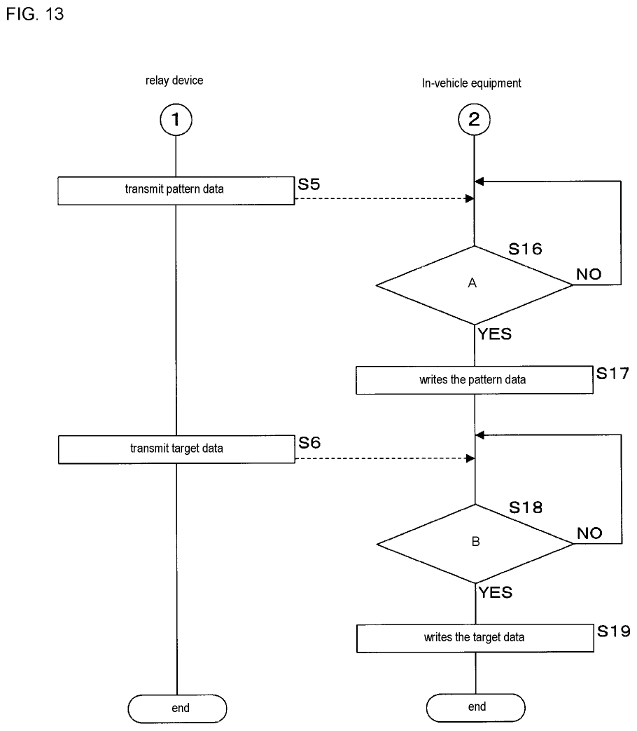

FIGS. 12 and 13 are flowcharts showing the procedure of initial setting performed by the relay device 2 and the in-vehicle equipment 3a. In the initial setting, the device control unit 23 of the relay device 2 performs data transmission processing. The equipment control unit 33 of the in-vehicle equipment 3a performs adjustment processing. The device control unit 23 of the relay device 2 performs data transmission processing when the in-vehicle equipment 3a is disconnected from the connector 2a. The equipment control unit 33 of the in-vehicle equipment 3a performs adjustment processing when the in-vehicle equipment 3a is connected to the connector 2a.

In the data transmission processing, the device control unit 23 determines whether or not the in-vehicle equipment 3a is connected to the connector 2a (step S1). When it is determined that the in-vehicle equipment 3a is not connected to the connector 2a (S1: NO), the device control unit 23 executes step S1 again and waits until the in-vehicle equipment 3a is connected to the connector 2a. When it is determined that the in-vehicle equipment 3a is connected to the connector 2a (S1: YES), the device control unit 23 instructs the device communication IC 21a to transmit count data indicating the count value of the master counter 20 to the equipment communication IC 31 of the in-vehicle equipment 3a (step S2).

In the adjustment processing, the equipment control unit 33 of the in-vehicle equipment 3a determines whether or not the equipment communication IC 31 has received the count data (step S11). When it is determined that the equipment communication IC 31 has not received the count data (S11: NO), the equipment control unit 33 executes step S11 again and waits until the equipment communication IC 31 receives the count data. When it is determined that the equipment communication IC 31 has received the count data (S11: YES), the equipment control unit 33 adjusts the count value of the slave counter 30 to the count value indicated by the count data received by the equipment communication IC 31 (step S12).

Then, the equipment control unit 33 instructs the equipment communication IC 31 to transmit request data to the device communication IC 21a of the relay device 2 (step S13). The request data includes equipment transmission count information indicating the count value of the slave counter 30 at the point in time when the request data is transmitted. The count value of the slave counter 30 at the point in time when the request data is transmitted is hereinafter referred to as an equipment transmission count value.

After executing step S2, the device control unit 23 of the relay device 2 determines whether or not the device communication IC 21a has received the request data (step S3). When it is determined that the device communication IC 21a has not received the request data (S3: NO), the device control unit 23 executes step S3 again and waits until the device communication IC 21a receives the request data. When it is determined that the device communication IC 21a has received the request data (S3: YES), the device control unit 23 instructs the device communication IC 21a to transmit response data to the equipment communication IC 31 of the in-vehicle equipment 3a (step S4).

The response data includes the equipment transmission count information included in the request data, device reception count information, and device transmission count information. The device reception count information indicates the count value of the master counter 20 at the point in time when the device communication IC 21a receives the request data. The device transmission count information indicates the count value of the master counter 20 at the point in time when the device communication IC 21a transmits the response data. The count value of the master counter 20 at the point in time when the device communication IC 21a receives the request data is hereinafter referred to as a device reception count value. The count value of the master counter 20 at the point in time when the device communication IC 21a transmits the response data will be referred to as a device transmission count value.

After executing step S13, the equipment control unit 33 of the in-vehicle equipment 3a determines whether or not the equipment communication IC 31 has received the response data from the device communication IC 21a of the relay device 2 (step S14). When it is determined that the equipment communication IC 31 has not received the response data (S14: NO), the equipment control unit 33 executes step S14 again and waits until the equipment communication IC 31 receives the response data.

Hereinafter, the count value of the slave counter 30 at the point in time when the equipment communication IC 31 receives the response data will be referred to as a device reception count value. As described above, the response data includes equipment transmission count information, device reception count information, and device transmission count information.

The equipment transmission count value, the device reception count value, the device transmission count value, and the equipment reception count value are represented by Het, Hrr, Hrt, and Her, respectively. It is assumed that the propagation times of request data and response data are the same. In this case, a difference Hd between the count values of the master counter 20 and the slave counter 30 is expressed by the following Equation (1).

$$Hd = ( ( Hrr - H et ) - ( Her - Hrt ) ) / 2 \qquad ( 1 )$$

When it is determined that the equipment communication IC 31 has received the response data (S14: YES), the equipment control unit 33 finely adjusts the count value of the slave counter 30 based on the difference Hd (step S15). As described above, when the equipment communication IC 31 of the in-vehicle equipment 3a receives the count data from the device communication IC 21a of the relay device 2, the equipment control unit 33 adjusts the count value of the slave counter 30 to the count value indicated by the count data received by the equipment communication IC 31. Therefore, the count value of the slave counter 30 is smaller than the actual count value of the master counter 20.

In step S15, the equipment control unit 33 increases the count value of the slave counter 30 by the absolute value of the difference Hd. As a result, the count value of the slave counter 30 substantially matches the count value of the master counter 20.

In addition, in Equation (1), when Hrr is smaller than Het, a numerical value required for the count value to reach Hrr from Het is used as (Hrr-Het). When Hrt is smaller than Her, a numerical value required for the count value to reach Her from Hrt is used as (Her−Hrt).

In addition, the method of calculating the difference Hd is not limited to the method using Equation (1).

After executing step S4, the device control unit 23 of the relay device 2 instructs the device communication IC 21a to transmit pattern data to the equipment communication IC 31 of the in-vehicle equipment 3a (step S5). After executing step S15, the equipment control unit 33 of the in-vehicle equipment 3a determines whether or not the equipment communication IC 31 has received the pattern data from the device communication IC 21a (step S16). When it is determined that the equipment communication IC 31 has not received the pattern data (S16: NO), the equipment control unit 33 executes step S16 again and waits until the equipment communication IC 31 receives the pattern data.

When it is determined that the equipment communication IC 31 has received the pattern data (S16: YES), the equipment control unit 33 writes the pattern data received by the equipment communication IC 31 into the equipment storage unit 32 (step S17).

After executing step S5, the device control unit 23 of the relay device 2 instructs the device communication IC 21a to transmit target data for the in-vehicle equipment 3a to the equipment communication IC 31 of the in-vehicle equipment 3a (step S6). After executing step S6, the device control unit 23 ends the data transmission processing. When the in-vehicle equipment 3a is disconnected from the connector 2a, the device control unit 23 performs the data transmission processing again.

After executing step S17, the equipment control unit 33 of the in-vehicle equipment 3a determines whether or not the equipment communication IC 31 has received the target data for the in-vehicle equipment 3a from the device communication IC 21a (step S18). When it is determined that the equipment communication IC 31 has not received the target data (S18: NO), the equipment control unit 33 executes step S18 again and waits until the equipment communication IC 31 receives the target data.

When it is determined that the equipment communication IC 31 has received the target data for the in-vehicle equipment 3a (S18: YES), the equipment control unit 33 writes the target data for the in-vehicle equipment 3a received by the equipment communication IC 31 into the equipment storage unit 32 (step S19). After executing step S19, the equipment control unit 33 ends the adjustment processing. After the in-vehicle equipment 3a is disconnected from the connector 2a, when the in-vehicle equipment 3a is reconnected to the connector 2a, the equipment control unit 33 performs the adjustment processing again.

As described above, when the data transmission processing and the adjustment processing have been performed by the device control unit 23 and the equipment control unit 33, respectively, the count values of the master counter 20 and the slave counter 30 are substantially the same. In addition, pattern data and target data for the in-vehicle equipment 3a are stored in the equipment storage unit 32 of the in-vehicle equipment 3a.

In addition, when the count number and the predetermined period of the slave counter 30 are not the same as the count number and the predetermined period of the master counter 20, the device communication IC 21a of the relay device 2 transmits count data indicating the count value, the count number, and the predetermined period of the master counter 20 to the equipment communication IC 31 of the in-vehicle equipment 3a in step S2. When the equipment communication IC 31 receives the count data, the equipment control unit 33 adjusts the count value, the count number, and the predetermined period of the slave counter 30 to the count value, the count number, and the predetermined period indicated by the count data.

Initial setting performed by the relay device 2 and the pieces of in-vehicle equipment 3b and 3c is the same as the initial setting performed by the relay device 2 and the in-vehicle equipment 3a. The connector 2a corresponds to the connectors 2b and 2c. The device communication IC 21a corresponds to the device communication ICs 21b and 21c.

### Outline of Method for Determining Entire Period

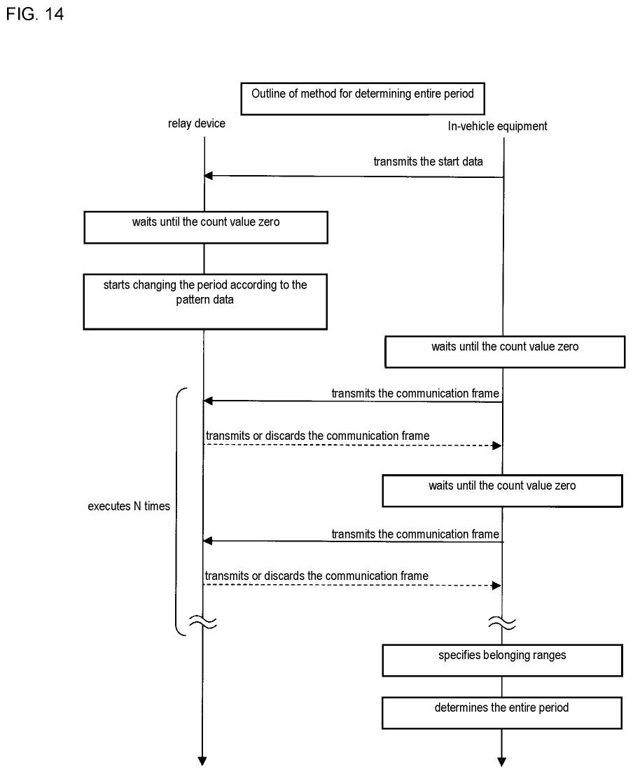

FIG. 14 is a sequence diagram for explaining the outline of a method of determining the entire period of the in-vehicle equipment 3a. After the count value of the master counter 20 is synchronized with the count value of the slave counter 30, the in-vehicle equipment 3a determines the entire period of the in-vehicle equipment 3a. First, the in-vehicle equipment 3a transmits start data to the relay device 2. When the start data is received, the relay device 2 waits until the count value of the master counter 20 becomes zero.

When the count value becomes zero, the relay device 2 starts changing the period according to the pattern data. As described above, the relay device 2 changes the total number, the position of the boundary, and the like according to the pattern data for the open periods and the close periods of the communication queue Qm over the first to Kth cycles. The boundary to be changed is the boundary between the open period and the close period. The relay device 2 repeats changing the period N times according to the pattern data. Here, N is an integer of 2 or more.

After transmitting the start data, the in-vehicle equipment 3a waits until the count value of the slave counter 30 becomes zero. The in-vehicle equipment 3a transmits a communication frame to the relay device 2 when the count value becomes zero. When the communication frame is received, the relay device 2 writes the received communication frame into the reception buffer Ra. Then, the relay device 2 moves the communication frame stored in the reception buffer Ra to the transmission buffer Ta. Then, the relay device 2 determines whether or not a communication frame is stored in the transmission buffer Ta.

When it is determined that a communication frame is stored in the transmission buffer Ta, the relay device 2 specifies a period, to which the communication determination time at which the determination has been performed belongs, from the open period and the close period of the communication queue Qm. When the specified period is an open period, the relay device 2 transmits the communication frame to the in-vehicle equipment 3a. When the specified period is a close period, the relay device 2 discards the communication frame. Therefore, for the in-vehicle equipment 3a, receiving the communication frame means that the period specified by the relay device 2 is an open period. For the in-vehicle equipment 3a, not receiving the communication frame means that the period specified by the relay device 2 is a closed period. The reception result corresponds to a specifying result for a period.

The in-vehicle equipment 3a transmits a communication frame to the relay device 2 each time the count value becomes zero. The in-vehicle equipment 3a transmits a communication frame to the relay device 2 (K·N) times. Based on the (K·N) reception results, N belonging ranges to which the communication determination time belong are specified.

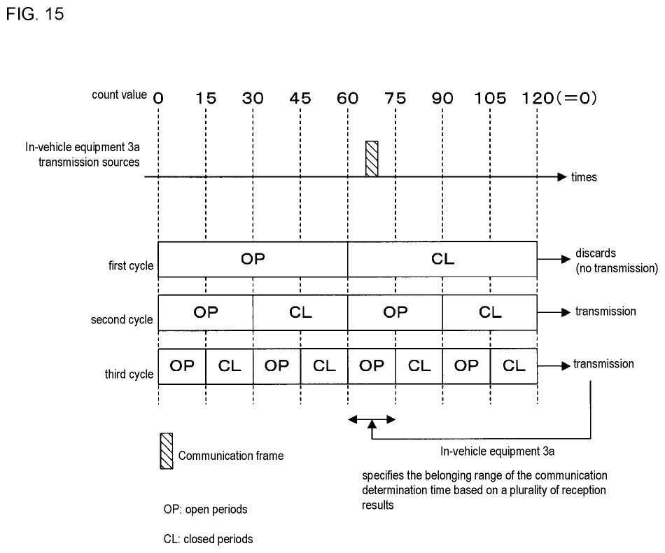

FIG. 15 is an explanatory diagram of a method of determining a belonging range. FIG. 15 shows an example using the pattern data shown in FIG. 9. In the example of FIG. 9, K is 3. The in-vehicle equipment 3a specifies a belonging range based on the K reception results. FIG. 15 shows an example in which K communication determination times received from the in-vehicle equipment 3a by the relay device 2 are 67. The in-vehicle equipment 3a does not recognize that the communication determination times are 67. For this reason, the in-vehicle equipment 3a does not even recognize the belonging range to which the communication determination time belongs. The in-vehicle equipment 3a receives the pattern data from the relay device 2.

When the communication determination times are 67, the relay device 2 discards communication frames transmitted from the in-vehicle equipment 3a in the first cycle. The relay device 2 transmits communication frames transmitted from the in-vehicle equipment 3a in the second cycle to the in-vehicle equipment 3a. The relay device 2 transmits communication frames transmitted from the in-vehicle equipment 3a in the third cycle to the in-vehicle equipment 3a. Based on the three reception results, the in-vehicle equipment 3a recognizes that the three periods specified by the relay device 2 in the first, second, and third cycles are a close period, an open period, and an open period, respectively.

When a range in which the three periods are a close period, an open period, and an open period is the belonging range, in the example of FIG. 15, the belonging range is a range of 60 to 74. In this manner, the in-vehicle equipment 3a specifies the belonging range based on the K reception results.

In addition, open periods and close periods of the pattern data are arranged so that the number of ranges in which three periods corresponding to the three cycles are a close period, an open period, and an open period is one. Specifically, in the i-th cycle of the pattern data, open periods and close periods are arranged so that the number of open periods present within the common range of the first to (i−1)-th cycles and the number of close periods present within the common range of the first to (i−1)-th cycles are 1 or less.

In FIG. 15, the number of common ranges of the first cycle is two. The first common range is an open period of the first cycle. The second common range is a close period of the first cycle. For the second cycle, the number of open periods belonging to each common range and the number of close periods belonging to each common range are one.

The number of common ranges of the first cycle and the second cycle is four. The first common range is a range in which periods corresponding to the first cycle and the second cycle are an open period and an open period, respectively. The second common range is a range in which periods corresponding to the first cycle and the second cycle are an open period and a closed period, respectively. The third common range is a range in which periods corresponding to the first cycle and the second cycle are a closed period and an open period, respectively. The fourth common range is a range in which periods corresponding to the first cycle and the second cycle are a closed period and a closed period, respectively. For the third cycle, the number of open periods belonging to each common range of the first cycle and the second cycle and the number of close periods belonging to each common range of the first cycle and the second cycle are one. Within the common range, only open periods or only close periods may be arranged.

As shown in FIG. 14, after specifying the N belonging ranges, the in-vehicle equipment 3a determines the entire period of the in-vehicle equipment 3a based on the specified N belonging ranges. The entire period is indicated by the width of the count value from the transmission instruction value indicating transmission of the communication frame to the communication determination time. The transmission instruction value is a count value. As described above, the count value is incremented by 1 each time a predetermined period passes. Thus, the entire period is the product of the width of the count value and the predetermined period. As described above, the in-vehicle equipment 3a gives an instruction to transmit the communication frame when the count value is zero. Therefore, the count value at the communication determination time indicates the entire period.

In order to determine the entire period of the in-vehicle equipment 3a, the in-vehicle equipment 3a first determines a calculation value for calculating the entire period. When the specified N belonging ranges are the same, the in-vehicle equipment 3a determines the calculation value to be the median value of the specified belonging ranges. The in-vehicle equipment 3a determines the entire period to be the product of a predetermined period and a value obtained by subtracting the transmission instruction value (=0) of the communication frame from the determined calculation value. The determined entire period is indicated by the value obtained by subtracting the transmission instruction value from the calculation value. Two ranges may be included in the N belonging ranges specified by the in-vehicle equipment 3a. That is, there may be ranges E1 and E2 as belonging ranges.

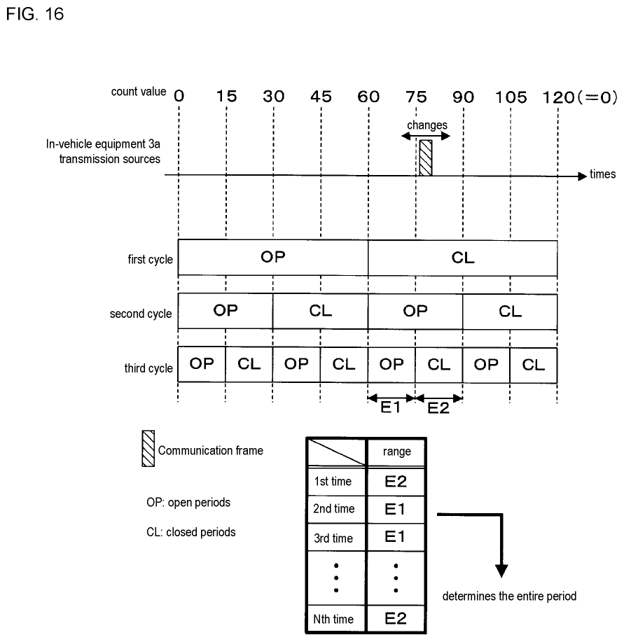

FIG. 16 is an explanatory diagram of a method of determining the entire period when there are the two ranges E1 and E2 as belonging ranges. When the in-vehicle equipment 3a transmits a plurality of communication frames, there is a possibility that the communication determination times of these communication frames will not be the same. That is, there is a possibility that the communication determination time will change.

In the example of FIG. 16, the communication determination time changes around 75. The range E1 is a range of 60 to 74. The range E2 is a range of 75 to 89. When there are the two ranges E1 and E2 as belonging ranges, the in-vehicle equipment 3a determines the calculation value of the entire period to be a value within a majority range, which is larger in number between the ranges E1 and E2. The in-vehicle equipment 3a determines the calculation value of the entire period to be a value closer to a minority range as the number of minority ranges, which is smaller in number between the ranges E1 and E2, becomes larger.

For example, when the number of ranges E2 is larger than the number of ranges E1, the in-vehicle equipment 3a determines the calculation value to be a value within the range E2. The in-vehicle equipment 3a determines the calculation value to be a value closer to the range E1 within the range E2 as the number of ranges E1 becomes larger. As a result, the entire period is determined in consideration of the variation in communication determination time.

In addition, the method of determining the entire period is not limited to the above-described determination method. There is no problem if the entire period is determined based on the specified N belonging ranges.

The method of determining the entire period of each of the pieces of in-vehicle equipment 3b and 3c is the same as the method of determining the entire period of the in-vehicle equipment 3a. Hereinafter, for the method of determining the entire period, specific processes performed by the device control unit 23 of the relay device 2 and the pieces of in-vehicle equipment 3a, 3b, and 3c will be described.

### Change of Period According to Pattern Data

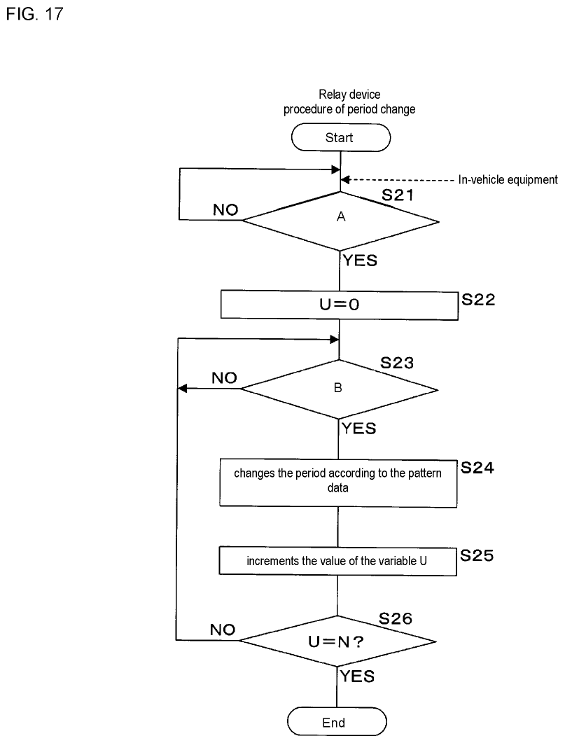

FIG. 17 is a flowchart showing the procedure of period change processing corresponding to the communication queue Qm of the transmission buffer Ta. The period change processing is performed by the device control unit 23 of the relay device 2 after the initial setting is performed. The value of a variable U is stored in the device storage unit 22 of the relay device 2. The device control unit 23 changes the value of the variable U. In the period change processing, first, the device control unit 23 determines whether or not the device communication IC 21a has received start data from the in-vehicle equipment 3a (step S21). When it is determined that the device communication IC 21a has not received the start data (S21: NO), the device control unit 23 executes step S21 again and waits until the device communication IC 21a receives the start data.

When it is determined that the device communication IC 21a has received the start data (S21: YES), the device control unit 23 sets the value of the variable U to zero (step S22), and determines whether or not the count value of the master counter 20 is zero (step S23). When it is determined that the count value is not zero (S23: NO), the device control unit 23 executes step S23 again and waits until the count value becomes zero.

When it is determined that the count value is zero (S23: YES), the device control unit 23 changes the period according to the pattern data (step S24). As described above, the device control unit 23 changes the total number of open periods and close periods included in the next period according to the pattern data each time one cycle passes. The device control unit 23 changes the total number of open periods and close periods included in each cycle so that the total numbers included in the consecutive K cycles are different. Then, the device control unit 23 increments the value of the variable U by 1 (step S25).

After executing step S25, the device control unit 23 determines whether or not the value of the variable U is N (step S26). When it is determined that the value of the variable U is not N (S26: NO), the device control unit 23 executes step S23 to change the period again according to the pattern data. When it is determined that the value of the variable U is N (S26: YES), the device control unit 23 ends the period change processing. After ending the period change processing, the device control unit 23 performs the period change processing again.

As described above, in the period change processing, the device control unit 23 repeats the period change according to the pattern data N times. The period change processing corresponding to the communication queue Qm of the transmission buffers Tb and Tc is the same as the period change processing corresponding to the communication queue Qm of the transmission buffer Ta. The device communication IC 21a corresponds to the device communication ICs 21b and 21c. The in-vehicle equipment 3a corresponds to the pieces of in-vehicle equipment 3b and 3c.

### Movement of Communication Frames and Relay Frames Performed by Relay Device

As described above, the device control unit 23 of the relay device 2 performs data movement processing. In the data movement processing, the device control unit 23 writes the communication frames received by the device communication ICs 21a, 21b, and 21c into the reception buffers Ra, Rb, and Rc of the device storage unit 22, respectively. The device control unit 23 moves the communication frames stored in the reception buffers Ra, Rb, and Rc to the communication queues Qm of the transmission buffers Ta, Tb, and Tc, respectively. The device storage unit 22 functions as a relay storage unit.

The device control unit 23 writes the relay frames received by the device communication ICs 21a, 21b, and 21c into the reception buffers Ra, Rb, and Rc, respectively. The device control unit 23 moves relay frames whose transmission destination is the in-vehicle equipment 3a, among the relay frames stored in the reception buffers Rb and Rc, to the transmission buffer Ta. Here, the device control unit 23 moves the first relay frame to the first queue Q1 of the transmission buffer Ta. The device control unit 23 moves the second relay frame to the second queue Q2 of the transmission buffer Ta.

Similarly, the device control unit 23 moves relay frames whose transmission destination is the in-vehicle equipment 3b, among the relay frames stored in the reception buffers Ra and Rc, to the transmission buffer Tb. Here, the device control unit 23 moves the first relay frame to the first queue Q1 of the transmission buffer Tb. The device control unit 23 moves the second relay frame to the second queue Q2 of the transmission buffer Tb. The device control unit 23 moves relay frames whose transmission destination is the in-vehicle equipment 3c, among the relay frames stored in the reception buffers Ra and Rb, to the transmission buffer Tc. Here, the device control unit 23 moves the first relay frame to the first queue Q1 of the transmission buffer Tc. The device control unit 23 moves the second relay frame to the second queue Q2 of the transmission buffer Tc.

### Communication Frame Relay Performed by Relay Device

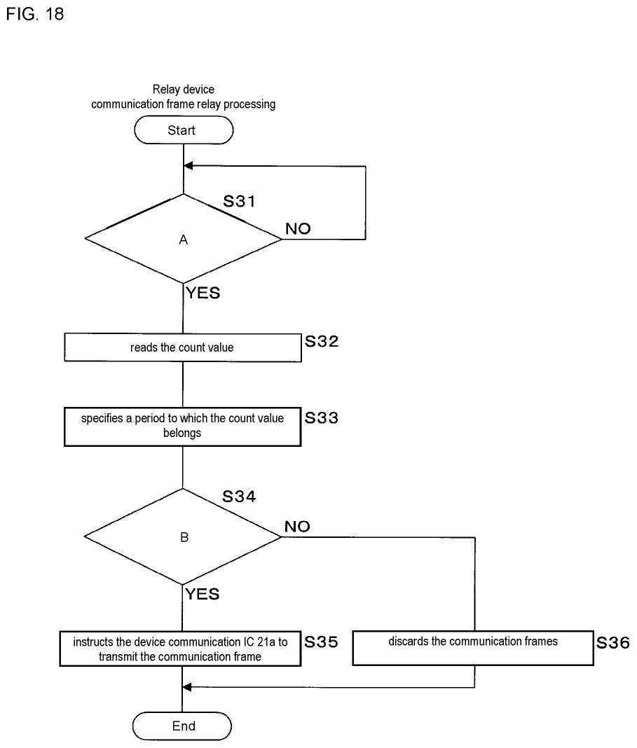

FIG. 18 is a flowchart showing the procedure of the communication frame relay processing of the transmission buffer Ta. In the communication frame relay processing of the transmission buffer Ta, the device control unit 23 of the relay device 2 determines whether or not a communication frame is stored in the communication queue Qm of the transmission buffer Ta (step S31). When it is determined that no communication frame is stored in the communication queue Qm (S31: NO), the device control unit 23 executes step S31 again and waits until the communication frame is written in the communication queue Qm.

When it is determined that the communication frame is stored in the communication queue Qm (S31: YES), the device control unit 23 reads the count value of the master counter 20 (step S32). The count value read in step S32 corresponds to the communication determination time at which it is determined that the communication frame is stored in the communication queue Qm. Then, the device control unit 23 specifies a period to which the count value read in step S32 belongs, among the open periods and close periods of the communication queue Qm (step S33).

Then, the device control unit 23 determines whether or not the period specified in step S33 is an open period (step S34). The fact that the specified period is not an open period means that the specified period is a close period. When it is determined that the specified period is an open period (S34: YES), the device control unit 23 instructs the device communication IC 21a to transmit the communication frame stored in the communication queue Qm (step S35). Then, the device communication IC 21a transmits the communication frame to the equipment communication IC 31 of the in-vehicle equipment 3a. The transmitted communication frame is discarded.

When it is determined that the specified period is not the open period (S34: NO), the device control unit 23 discards the communication frames stored in the communication queue Qm (step S36). After executing one of steps S35 and S36, the device control unit 23 ends the communication frame relay processing of the transmission buffer Ta. Thereafter, the device control unit 23 performs the communication frame relay processing of the transmission buffer Ta again.

As described above, in the communication frame relay processing, the device control unit 23 instructs the device communication IC 21a to transmit to the in-vehicle equipment 3a a communication frame whose communication determination time belongs to the open period.

The communication frame relay processing of each of the transmission buffers Tb and Tc is the same as the communication frame relay processing of the transmission buffer Ta. The device communication IC 21a corresponds to the device communication ICs 21b and 21c. The in-vehicle equipment 3a corresponds to the pieces of in-vehicle equipment 3b and 3c.

### Determination of Entire Period

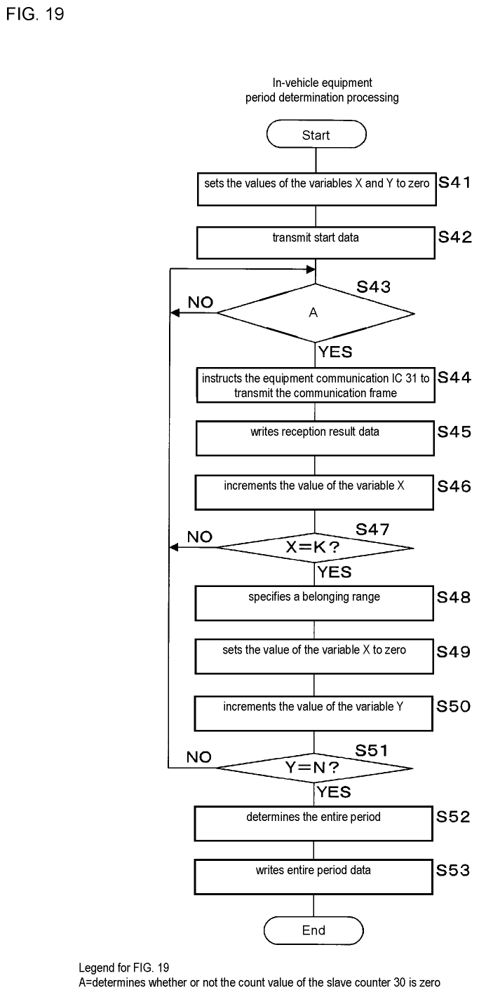

FIG. 19 is a flowchart showing the procedure of period determination processing of the in-vehicle equipment 3a. The period change processing of the in-vehicle equipment 3a is performed by the equipment control unit 33 after the initial setting is performed. The values of variables X and Y are stored in the equipment storage unit 32 of the in-vehicle equipment 3a. The equipment control unit 33 changes the values of the variables X and Y.

In the period determination processing, first, the equipment control unit 33 of the in-vehicle equipment 3a sets the values of the variables X and Y to zero (step S41). Then, the equipment control unit 33 instructs the equipment communication IC 31 to transmit start data to the device communication IC 21a of the relay device 2 (step S42). After executing step S42, the equipment control unit 33 determines whether or not the count value of the slave counter 30 is zero (step S43). Here, zero is a predetermined transmission instruction value of the communication frame. When it is determined that the count value is not zero (transmission instruction value of the communication frame) (S43: NO), the equipment control unit 33 executes step S43 again and waits until the count value becomes zero.

When it is determined that the count value is zero (communication frame transmission instruction value) (S43: YES), the equipment control unit 33 instructs the equipment communication IC 31 to transmit the communication frame to the device communication IC 21a of the relay device 2 (step S44). Here, the transmission destination of the communication frame is the in-vehicle equipment 3a. When step S44 is executed, the equipment communication IC 31 transmits the communication frame to the device communication IC 21a of the relay device 2. As described above, the device communication IC 21a of the relay device 2 transmits the communication frame to the equipment communication IC 31 when the communication determination time belongs to the open period. The device communication IC 21a of the relay device 2 discards the communication frame when the communication determination time belongs to the close period.

After executing step S44, the equipment control unit 33 writes reception result data indicating the reception result of the equipment communication IC 31 regarding the communication frame into the equipment storage unit 32 (step S45). Then, the equipment control unit 33 increments the value of the variable X by 1 (step S46). After executing step S46, the equipment control unit 33 determines whether or not the value of the variable X is K (step S47). When it is determined that the value of the variable X is not K (S47: NO), the equipment control unit 33 executes step S43 again. When the count value becomes zero, that is, when the next cycle arrives, the equipment control unit 33 instructs the device communication IC 21a to transmit a communication frame. As described above, the equipment control unit 33 instructs the device communication IC 21a to transmit a communication frame each time one cycle elapses. The device communication IC 21a receives a communication frame from the equipment communication IC 31 of the in-vehicle equipment 3a each time one cycle elapses.

When it is determined that the value of the variable X is K (S47: YES), the equipment control unit 33 specifies a belonging range to which the communication determination time belongs in one cycle based on the K reception results, as described with reference to FIG. 15 (step S48). Then, the equipment control unit 33 sets the value of the variable X to zero (step S49), and increments the value of the variable Y by 1 (step S50). After executing step S50, the equipment control unit 33 determines whether or not the value of the variable Y is N (step S51).

When it is determined that the value of the variable Y is not N (S51: NO), the equipment control unit 33 executes step S43 again and gives an instruction to transmit communication frames K times. As described above, the equipment control unit 33 specifies the belonging range N times. When it is determined that the value of the variable Y is N (S51: YES), the equipment control unit 33 determines the entire period of the in-vehicle equipment 3a as described above (step S52). Then, the equipment control unit 33 writes entire period data indicating the entire period determined in step S52 into the equipment storage unit 32 (step S53). After executing step S53, the equipment control unit 33 ends the period determination processing.

As described above, the equipment control unit 33 specifies the belonging range of the communication determination time based on the K reception results. Based on the specified N belonging ranges, the equipment control unit 33 determines the entire period in consideration of the variation in communication determination time.

The period determination processing of each of the pieces of in-vehicle equipment 3b and 3c is the same as the period determination processing of the in-vehicle equipment 3a. The device communication IC 21a corresponds to the device communication ICs 21b and 21c.

### Relay Frame Relay Performed by Relay Device

The device control unit 23 of the relay device 2 performs the first relay processing and the second relay processing of the transmission buffer Ta in the same manner as the communication frame relay processing of the transmission buffer Ta. In the description of the communication frame relay processing of the transmission buffer Ta, the communication frame, the communication determination time, and the communication queue Qm are replaced with the first relay frame, the relay determination time, and the first queue Q1, respectively. In this manner, the first relay processing of the transmission buffer Ta can be explained. In the description of the communication frame relay processing of the transmission buffer Ta, the communication frame, the communication determination time, and the communication queue Qm are replaced with the second relay frame, the relay determination time, and the second queue Q2, respectively. In this manner, the second relay processing of the transmission buffer Ta can be explained.

The device control unit 23 of the relay device 2 performs the first relay processing of each of the transmission buffers Tb and Tc in the same manner as the first relay processing of the transmission buffer Ta. The device control unit 23 of the relay device 2 performs the second relay processing of each of the transmission buffers Tb and Tc in the same manner as the second relay processing of the transmission buffer Ta. The transmission buffer Ta corresponds to the transmission buffers Tb and Tc.

### Data Frame Writing Performed by Each of Pieces of In-Vehicle Equipment

As described above, the equipment control unit 33 of each of the pieces of in-vehicle equipment 3a, 3b, and 3c performs writing processing. In a case where each of the pieces of in-vehicle equipment 3a, 3b, and 3c has a sensor, when sensor data is input from the sensor, the equipment control unit 33 generates a relay frame including the input sensor data in the writing processing. In a case where each of the pieces of in-vehicle equipment 3a, 3b, and 3c has a reception unit that receives an instruction, when the reception unit receives an instruction, the equipment control unit 33 generates a relay frame including instruction data indicating the received instruction in the writing processing. The equipment control unit 33 writes the generated relay frame into the equipment storage unit 32. The relay frame generated by the equipment control unit 33 is the first relay frame or the second relay frame.

### Transmission of Relay Frames Performed by Pieces of In-Vehicle Equipment

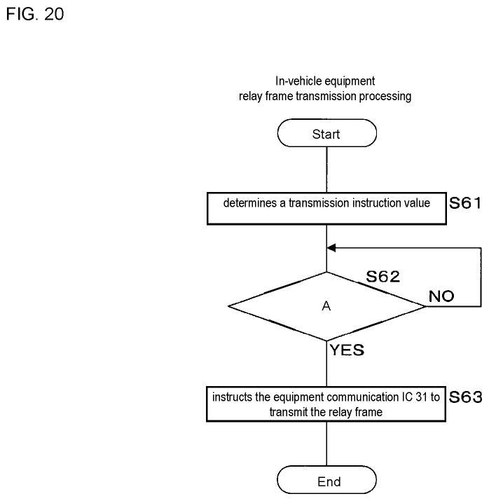

FIG. 20 is a flowchart showing the procedure of relay frame transmission processing of the in-vehicle equipment 3a. After executing the period determination processing, when a relay frame is written in the equipment storage unit 32, the equipment control unit 33 of the in-vehicle equipment 3a performs relay frame transmission processing. Entire period data indicating the entire period determined in the period determination processing is stored in the equipment storage unit 32.

In the relay frame transmission processing, the equipment control unit 33 determines a transmission instruction value of the relay frame based on the target time indicated by the target data and the entire period indicated by the entire period data (step S61). The transmission instruction value of the relay frame is the count value (point in time) of the slave counter 30 at which the equipment control unit 33 gives an instruction to transmit the relay frame. The transmission instruction value of the relay frame corresponds to the transmission instruction time.

It is assumed that the relay frame stored in the equipment storage unit 32 is the second relay frame whose transmission destination is the in-vehicle equipment 3b. In this case, as shown in FIG. 10, the target time of the second relay frame is 60. It is assumed that the width of the count value corresponding to the entire period is 30. In this case, the transmission instruction value of the relay frame is 30 (=60-30). It is assumed that the relay frame stored in the equipment storage unit 32 is the first relay frame whose transmission destination is the in-vehicle equipment 3b. In this case, the target time of the first relay frame is zero. When the count number is 120, the transmission instruction value of the relay frame is 90 (=0−30+120).

Then, the equipment control unit 33 determines whether or not the count value of the slave counter 30 is the transmission instruction value of the relay frame determined in step S61 (step S62). When it is determined that the count value is not the transmission instruction value of the relay frame (S62: NO), the equipment control unit 33 executes step S62 again and waits until the count value becomes the transmission instruction value determined in step S61.

When it is determined that the count value is the transmission instruction value of the relay frame (S62: YES), the equipment control unit 33 instructs the equipment communication IC 31 to transmit the relay frame stored in the equipment storage unit 32 to the relay device 2 (step S63). After executing step S63, the equipment control unit 33 ends the frame transmission processing.

As described above, the equipment communication IC 31 of the in-vehicle equipment 3a determines a transmission instruction value for giving an instruction to transmit the relay frame to the relay device 2, based on the determined entire period, so that the relay determination time of the relay frame belongs to the open period. The relay frame transmission processing of each of the pieces of in-vehicle equipment 3b and 3c is the same as the relay frame transmission processing of the in-vehicle equipment 3a.

### Second Embodiment

In the pattern data in the first embodiment, the total number of open periods and close periods included in the i-th cycle is 2 to the i power. As described above, i is any natural number equal to or less than K. However, in the pattern data, the total number of open periods and close periods included in the i-th period is not limited to 2 to the i power.

Hereinafter, the points of a second embodiment that are different from the first embodiment will be described. Since configurations other than those described later are the same as those of the first embodiment, the same components as in the first embodiment are denoted by the same reference numerals as in the first embodiment, and the description thereof will be omitted.

### Detail of Pattern Data

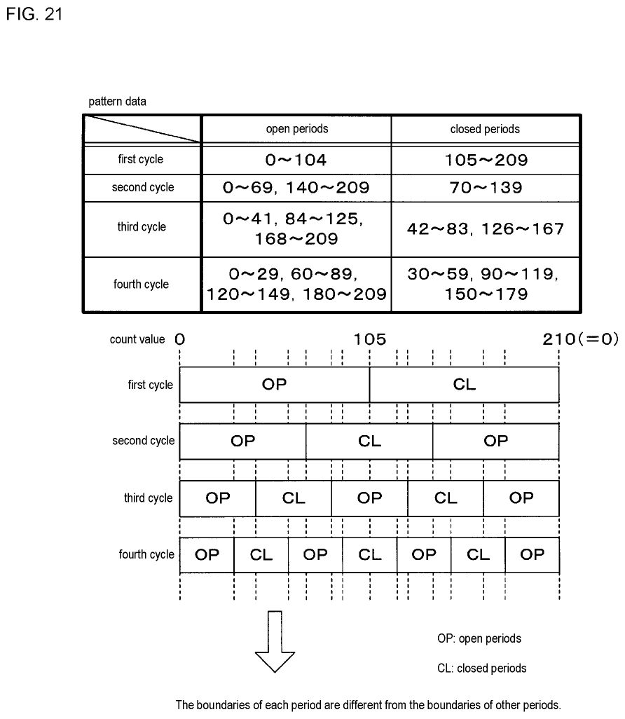

FIG. 21 is an explanatory diagram of the contents of pattern data in the second embodiment. FIG. 21 shows an example where the count number is 210 and K is 4. In the pattern data in the second embodiment, the total number of open periods and close periods in each cycle is a prime number. In the example of FIG. 21, the total numbers in the first, second, third, and fourth cycles are 2, 3, 5 and 7, respectively. For K cycles, the positions of boundaries between open periods and close periods are different.

In the i-th cycle of the pattern data, open periods and close periods are arranged so that the number of open periods present within the common range of the first to (i−1)-th cycles and the number of close periods present within the common range of the first to (i−1)-th cycles are 1 or less. In the example of FIG. 21, the lengths of a plurality of periods included in each cycle are the same.

### Change of Period According to Pattern Data

In step S24 of the period change processing, the device control unit 23 of the relay device 2 changes the period according to the pattern data, as in the first embodiment. Therefore, the device control unit 23 changes the positions of the boundaries within each cycle so that the positions of the boundaries between the open periods and the close periods are different for the K cycles.

In the pattern data in the first embodiment, as shown in FIG. 16, the boundaries in the three cycles match each other at 60 (count value). Therefore, when the communication determination time changes around 60, the period to which the communication determination time belongs is not fixed to one period in each of the first, second, and third cycles. For this reason, the device control unit 23 cannot accurately specify the belonging range to which the communication determination time belongs based on the K periods specified in the K cycles. However, in the second embodiment, the positions of boundaries between open periods and close periods are different for the K cycles. Therefore, even if the communication determination time changes, the device control unit 23 can accurately specify the belonging range.

In addition, as in the first embodiment, the length of each of a plurality of periods included in each cycle may be different from the length of at least one of the other periods. Therefore, in the pattern data, the lengths of a plurality of open periods and a plurality of close periods included in K cycles may be adjusted so that the lengths of all common ranges regarding the K cycles are the same. In addition, the total number of open periods and close periods in each cycle may not be a prime number.

### Effects of Communication System

The communication system 1 according to the second embodiment has the same effects as those of the communication system 1 according to the first embodiment.

### Third Embodiment

In the first embodiment, the device control unit 23 of the relay device 2 performs communication frame relay processing of each of the transmission buffers Ta, Tb, and Tc so that the equipment control unit 33 of each of the pieces of in-vehicle equipment 3a, 3b, and 3c is notified of the period to which the communication determination time belongs. However, the method of notifying of the period to which the communication determination time belongs is not limited to this method.

Hereinafter, the points of a third embodiment that are different from the first embodiment will be described. Since configurations other than those described later are the same as those of the first embodiment, the same components as in the first embodiment are denoted by the same reference numerals as in the first embodiment, and the description thereof will be omitted.

### Configuration of Relay Device

The processing element (computer) of the device control unit 23 in the second embodiment performs period notification processing of each of the transmission buffers Ta, Tb, and Tc instead of the communication frame relay processing of each of the transmission buffers Ta, Tb, and Tc by executing the computer program Pr. In each of the three period notification processes, the device control unit 23 notifies the pieces of in-vehicle equipment 3a, 3b, and 3c of the period to which the communication determination time belongs.

### Period Notification Processing

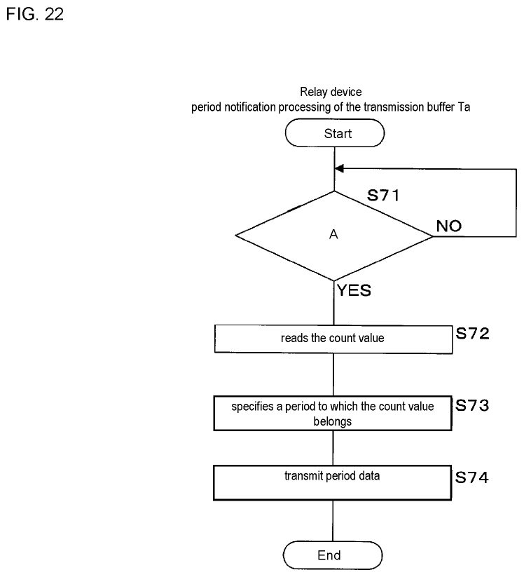

FIG. 22 is a flowchart showing the procedure of period notification processing of the transmission buffer Ta in the third embodiment. In the period notification processing of the transmission buffer Ta, the device control unit 23 of the relay device 2 determines whether or not a communication frame is stored in the communication queue Qm of the transmission buffer Ta (step S71). When it is determined that no communication frame is stored in the communication queue Qm (S71: NO), the device control unit 23 executes step S71 again and waits until the communication frame is written in the communication queue Qm.

When it is determined that the communication frame is stored in the communication queue Qm (S71: YES), the device control unit 23 reads the count value of the master counter 20 (step S72). The count value read in step S72 corresponds to the communication determination time at which it is determined that the communication frame is stored in the communication queue Qm. Then, the device control unit 23 specifies a period to which the count value read in step S72 belongs, among the open periods and close periods of the communication queue Qm (step S73).

Then, the device control unit 23 instructs the device communication IC 21a to transmit period data indicating the period specified in step S33 (step S74). The period data indicates, for example, the number of times the device control unit 23 specified the open period (or the close period). The equipment control unit 33 of the in-vehicle equipment 3a can recognize the period specified by the device control unit 23 based on whether or not the number of times indicated by the period data has increased. After executing step S74, the device control unit 23 ends the period notification processing of the transmission buffer Ta. Thereafter, the device control unit 23 performs the period notification processing of the transmission buffer Ta again.

As described above, the device communication IC 21a transmits period data to the equipment communication IC 31 each time a communication frame is received from the equipment communication IC 31 of the in-vehicle equipment 3a. In this manner, the in-vehicle equipment 3a is notified of the period specified by the device control unit 23.

The period notification processing of each of the transmission buffers Tb and Tc is the same as the period notification processing of the transmission buffer Ta. The device communication IC 21a corresponds to the device communication ICs 21b and 21c. The in-vehicle equipment 3a corresponds to the pieces of in-vehicle equipment 3b and 3c. In the third embodiment, the relay device 2 does not have to transmit communication frames to the pieces of in-vehicle equipment 3a, 3b, and 3c.

### Determination of Entire Period

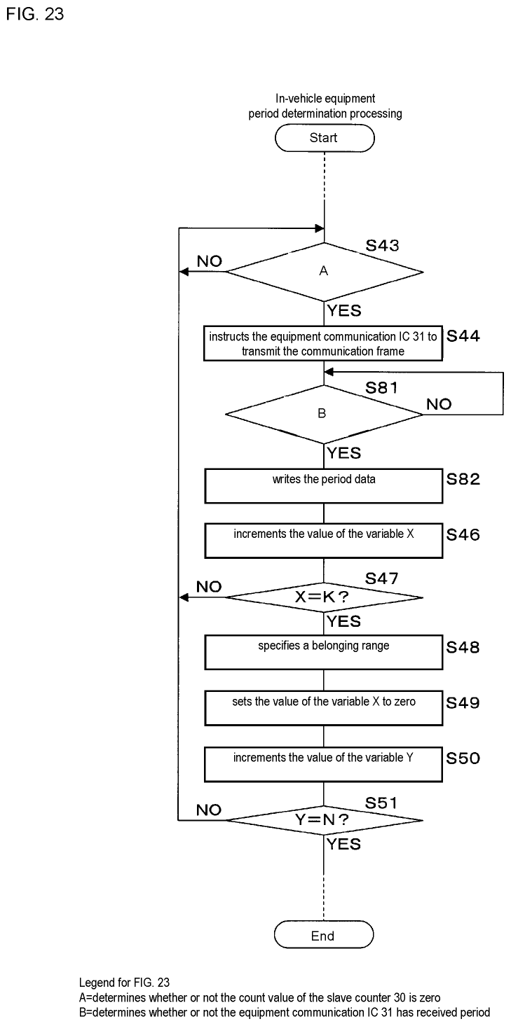

FIG. 23 is a flowchart showing the procedure of period determination processing of the in-vehicle equipment 3a. When the third embodiment is compared with the first embodiment, the contents of the period determination processing are different. In the period determination processing of the in-vehicle equipment 3a in the third embodiment, the equipment control unit 33 executes steps S41 to S44 and S46 to S53 as in the first embodiment. Therefore, detailed description thereof will be omitted.

In the period determination processing of the in-vehicle equipment 3a, after executing step S44, the equipment control unit 33 determines whether or not the equipment communication IC 31 has received period data from the device communication IC 21a of the relay device 2 (step S81). When it is determined that the equipment communication IC 31 has not received the period data (S81: NO), the equipment control unit 33 executes step S81 and waits until the equipment communication IC 31 receives the period data.

When it is determined that the equipment communication IC 31 has received the period data (S81: YES), the equipment control unit 33 writes the period data received by the equipment communication IC 31 into the equipment storage unit 32 (step S82). After executing step S82, the equipment control unit 33 executes step S46. In step S48, based on K periods indicated by K pieces of period data stored in the equipment storage unit 32, a belonging range to which the communication determination time belongs is specified.

As described above, the equipment control unit 33 specifies the belonging range of the communication determination time based on the K pieces of period data.

Also in the third embodiment, the period determination processing of each of the pieces of in-vehicle equipment 3b and 3c is the same as the period determination processing of the in-vehicle equipment 3a. The device communication IC 21a corresponds to the device communication ICs 21b and 21c.

### Effects of Communication System

The communication system 1 according to the third embodiment has the same effects as those of the communication system 1 according to the first embodiment.

In addition, in the third embodiment, the pattern data in the second embodiment may be used.

### Fourth Embodiment

In the first embodiment, the transmission instruction value of the relay frame is determined based on the entire period. However, the target determined based on the entire period may be different from the transmission instruction value of the relay frame.

Hereinafter, the points of a fourth embodiment that are different from the first embodiment will be described. Since configurations other than those described later are the same as those of the first embodiment, the same components as in the first embodiment are denoted by the same reference numerals as in the first embodiment, and the description thereof will be omitted.

### Initial Setting

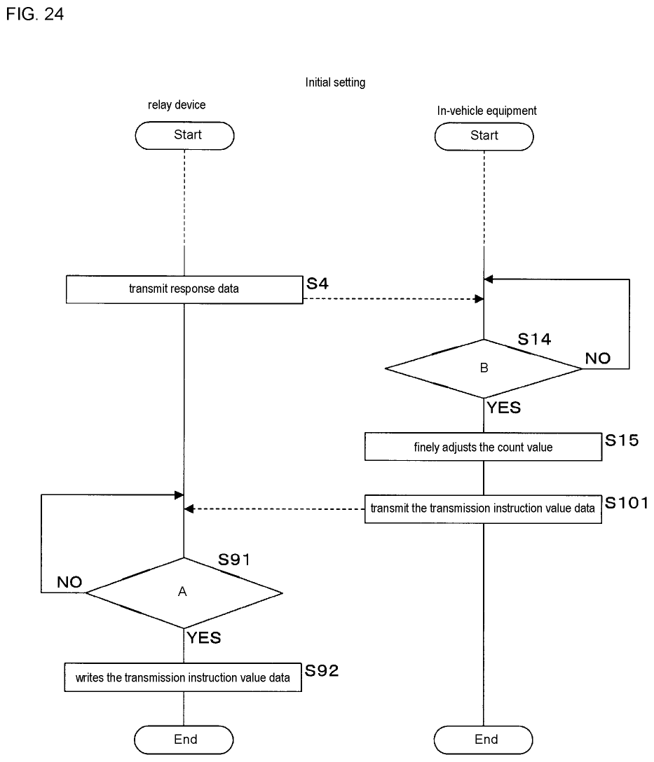

FIG. 24 is a flowchart showing the procedure of initial setting performed by the relay device 2 and the in-vehicle equipment 3a in the fourth embodiment. When the fourth embodiment is compared with the first embodiment, the contents of data transmission processing and adjustment processing are different. In the data transmission processing, the device control unit 23 of the relay device 2 executes steps S1 to S4 as in the first embodiment. In the adjustment processing, the equipment control unit 33 of the in-vehicle equipment 3a executes steps S11 to S15 as in the first embodiment. Therefore, the detailed description of steps S1 to S4 and S11 to S15 will be omitted.

In the adjustment processing, after executing step S15, the equipment control unit 33 instructs the equipment communication IC 31 to transmit the transmission instruction value data of the in-vehicle equipment 3a to the device communication IC 21a of the relay device 2 (step S101). The transmission instruction value data of the in-vehicle equipment 3a indicates the transmission instruction value of the relay frame transmitted from the in-vehicle equipment 3a. After executing step S101, the equipment control unit 33 ends the adjustment processing. The transmission instruction value of the relay frame is set in advance. The transmission instruction value data is stored in the equipment storage unit 32 in advance.

In the data transmission processing, after executing step S4, the device control unit 23 determines whether or not the device communication IC 21a has received the transmission instruction value data of the in-vehicle equipment 3a from the equipment communication IC 31 of the in-vehicle equipment 3a (step S91). When it is determined that the device communication IC 21a has not received the transmission instruction value data of the in-vehicle equipment 3a (S91: NO), the device control unit 23 executes step S91 again and waits until the device communication IC 21a receives the transmission instruction value data of the in-vehicle equipment 3a.

When it is determined that the device communication IC 21a has received the transmission instruction value data of the in-vehicle equipment 3a (S91: YES), the device control unit 23 writes the transmission instruction value data of the in-vehicle equipment 3a received by the device communication IC 21a into the device storage unit 22 (step S92). After executing step S92, the equipment control unit 33 ends the adjustment processing.

As described above, when the device control unit 23 performs initial setting together with the in-vehicle equipment 3a, the transmission instruction value data of the in-vehicle equipment 3a is stored in the device storage unit 22. The count value of slave counter 30 is synchronized with the count value of the master counter 20.

Initial setting performed by the relay device 2 and the pieces of in-vehicle equipment 3b and 3c is the same as the initial setting performed by the relay device 2 and the in-vehicle equipment 3a. The connector 2a of the in-vehicle equipment 3a and the device communication IC 21a correspond to the connector 2b of the in-vehicle equipment 3b and the device communication IC 21b, respectively. In addition, the connector 2a of the in-vehicle equipment 3a and the device communication IC 21a correspond to the connector 2c of the in-vehicle equipment 3c and the device communication IC 21c, respectively.

### Outline of Method of Determining Entire Period

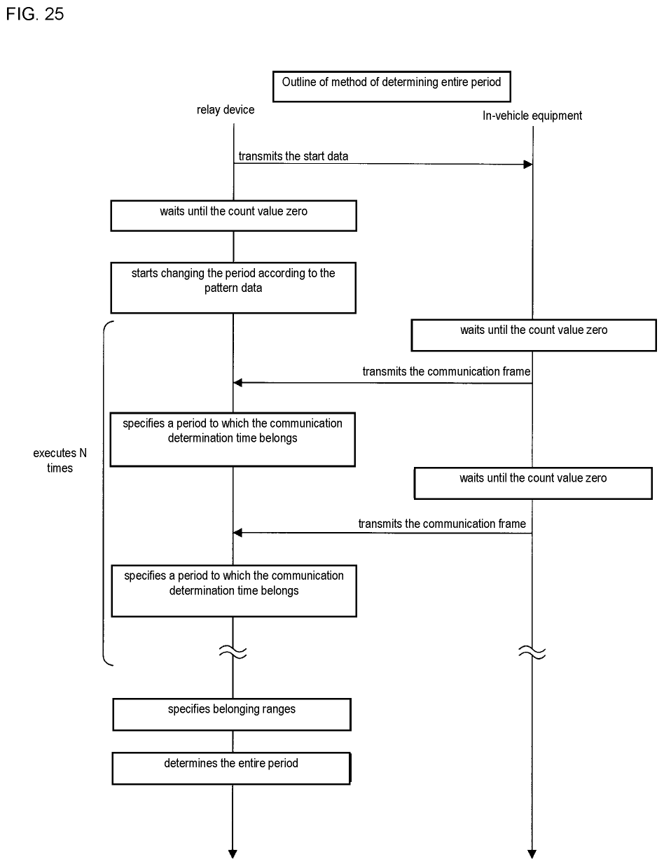

FIG. 25 is a sequence diagram for explaining the outline of a method of determining the entire period of the in-vehicle equipment 3a. In the fourth embodiment, after the initial setting is performed, the relay device 2 transmits the start data instead of the in-vehicle equipment 3a. When the start data is received, the in-vehicle equipment 3a waits until the count value of the slave counter 30 becomes zero. The in-vehicle equipment 3a transmits the communication frame to the relay device 2 when the count value becomes zero. Thereafter, the in-vehicle equipment 3a transmits a communication frame to the relay device 2 each time the count value becomes zero.

After transmitting the start data, the relay device 2 waits until the count value of the master counter 20 becomes zero. When the count value becomes zero, the relay device 2 starts changing the period according to the pattern data. The relay device 2 changes the period N times according to the pattern data. Each time a communication frame is received from the in-vehicle equipment 3a, the relay device 2 specifies a period to which the communication determination time (count value) of the received communication frame belongs among the open periods and the close periods of the communication queue Qm of the transmission buffer Ta.

The in-vehicle equipment 3a transmits a communication frame to the relay device 2 (K·N) times. Based on the (K·N) specifying results, the relay device 2 specifies N belonging ranges to which the communication determination time belongs. The relay device 2 determines the entire period of the in-vehicle equipment 3a based on the specified N belonging ranges. Specifying the belonging range by the relay device 2 is the same as specifying the belonging range by the in-vehicle equipment 3a in the first embodiment. Determining the entire period by the relay device 2 is the same as determining the entire period by the in-vehicle equipment 3a in the first embodiment.

The method of determining the entire period of each of the pieces of in-vehicle equipment 3b and 3c is the same as the method of determining the entire period of the in-vehicle equipment 3a.

Hereinafter, for the method of determining the entire period, specific processes performed by the device control unit 23 of the relay device 2 and the pieces of in-vehicle equipment 3a, 3b, and 3c will be described.

### Change of Period According to Pattern Data

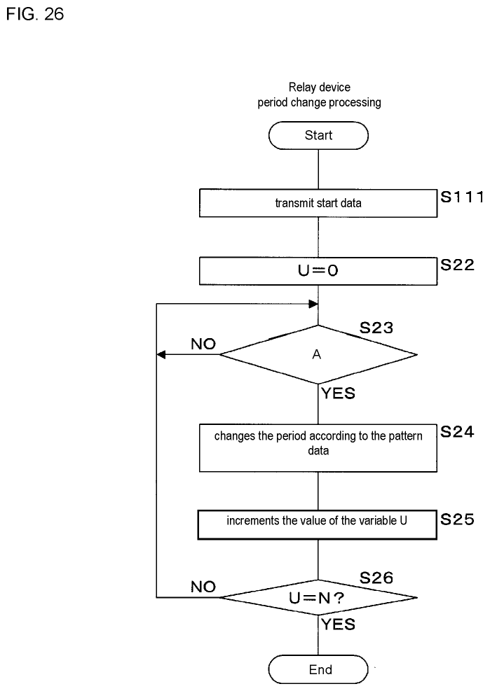

FIG. 26 is a flowchart showing the procedure of period change processing corresponding to the communication queue Qm of the transmission buffer Ta. When the fourth embodiment is compared with the first embodiment, the contents of the period change processing are different. In the period change processing of the fourth embodiment, the device control unit 23 of the relay device 2 executes steps S22 to S26 as in the first embodiment. Therefore, detailed description thereof will be omitted.

In the period change processing, first, the device control unit 23 instructs the device communication IC 21a to transmit start data to the equipment communication IC 31 of the in-vehicle equipment 3a (step S111). After executing step S111, the device control unit 23 executes step S22.

The period change processing corresponding to the communication queue Qm of the transmission buffers Tb and Tc is the same as the period change processing corresponding to the communication queue Qm of the transmission buffer Ta. The device communication IC 21a corresponds to the device communication ICs 21b and 21c. The in-vehicle equipment 3a corresponds to the pieces of in-vehicle equipment 3b and 3c.

### Configurations of the Pieces of In-Vehicle Equipment

The processing element (computer) of the equipment control unit 33 in the fourth embodiment performs communication frame transmission processing for transmitting the communication frame instead of the period determination processing by executing the computer program Pe.

### Communication Frame Transmission Processing

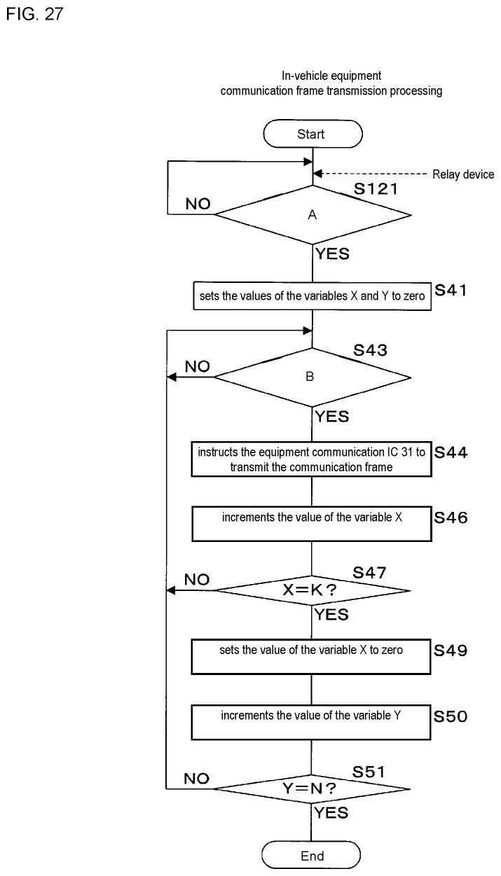

FIG. 27 is a flowchart showing the procedure of communication frame transmission processing of the in-vehicle equipment 3a. The communication frame transmission processing of the in-vehicle equipment 3a is performed by the equipment control unit 33 after the initial setting is performed. As in the first embodiment, the values of the variables X and Y are stored in the equipment storage unit 32 of the in-vehicle equipment 3a. In the communication frame transmission processing of the in-vehicle equipment 3a, the equipment control unit 33 executes steps S41, S43, S44, and S46 to S51 of the period determination processing in the first embodiment. Therefore, detailed description thereof will be omitted.

In the communication frame transmission processing of the in-vehicle equipment 3a, first, the equipment control unit 33 determines whether or not the equipment communication IC 31 has received the start data (step S121). When it is determined that the equipment communication IC 31 has not received the start data (S121: NO), the equipment control unit 33 executes step S121 again and waits until the equipment communication IC 31 receives the start data. When it is determined that the equipment communication IC 31 has received the start data (S121: YES), the equipment control unit 33 executes step S41.

After executing step S41, the equipment control unit 33 executes step S43. After executing step S44, the equipment control unit 33 executes step S46. When it is determined that the value of the variable Y is N (S51: YES), the equipment control unit 33 ends the communication frame transmission processing.

The communication frame transmission processing of each of the pieces of in-vehicle equipment 3b and 3c is the same as the communication frame transmission processing of the in-vehicle equipment 3a. The device communication IC 21a corresponds to the device communication ICs 21b and 21c.

### Transmission of Relay Frames Performed by Pieces of In-Vehicle Equipment

In the relay frame transmission processing (see FIG. 20) of each of the pieces of in-vehicle equipment 3a, 3b, and 3c, the equipment control unit 33 executes steps S62 and S63 without executing step S61. The transmission instruction value in step S62 is a transmission instruction value indicated by the transmission instruction value data. The equipment communication IC 31 of each of the pieces of in-vehicle equipment 3a, 3b, and 3c transmits the relay frame when the count value becomes the transmission instruction value indicated by the transmission instruction value data. In the fourth embodiment, no target data is used.

### Configuration of Relay Device

The processing element (computer) of the device control unit 23 in the fourth embodiment further performs period adjustment processing of each of the transmission buffers Ta, Tb, and Tc by executing the computer program Pr. The period adjustment processing is processing for adjusting the start time or length of the open period of each of the first queue Q1 and the second queue Q2. The values of variables Fa, Ga, Fb, Gb, Fc, and Gc used in the three period adjustment processes are stored in the device storage unit 22. These values are changed by the device control unit 23.

### Period Adjustment Processing

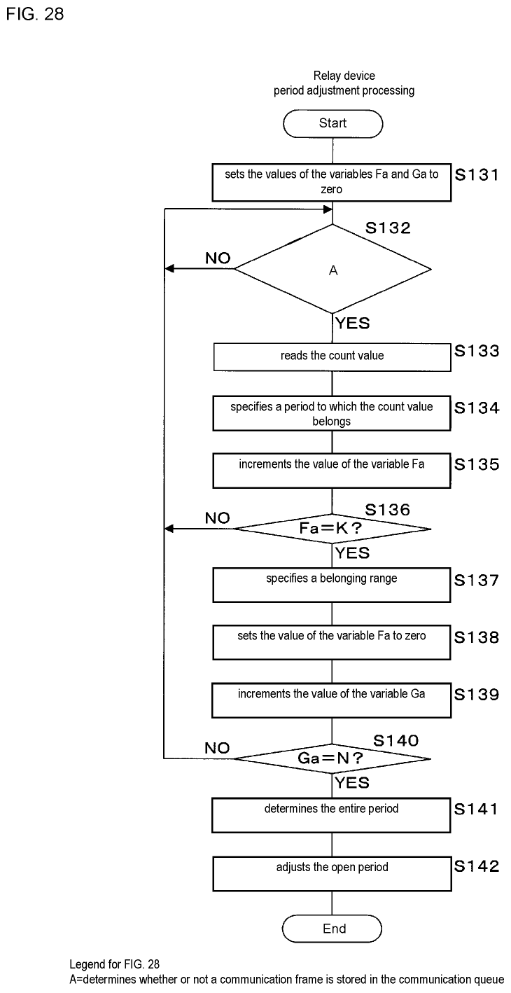

FIG. 28 is a flowchart showing the procedure of period adjustment processing of the transmission buffer Ta. The period adjustment processing of the transmission buffer Ta is performed by the device control unit 23 in parallel with the communication frame transmission processing of the in-vehicle equipment 3a after the initial setting is performed. In the period adjustment processing of the transmission buffer Ta, first, the device control unit 23 sets the values of the variables Fa and Ga to zero (step S131). Then, the device control unit 23 determines whether or not a communication frame is stored in the communication queue Qm of the transmission buffer Ta (step S132). When it is determined that no communication frame is stored in the communication queue Qm (S132: NO), the device control unit 23 waits until the communication frame is stored in the communication queue Qm.

When it is determined that the communication frame is stored in the communication queue Qm (S132: YES), the device control unit 23 reads the count value of the master counter 20 (step S133). The count value read in step S133 corresponds to the communication determination time at which it is determined that the communication frame is stored in the communication queue Qm. Then, the device control unit 23 specifies a period to which the count value read in step S133 belongs, among the open periods and close periods of the communication queue Qm (step S134). After executing step S134, the device control unit 23 increments the value of the variable Fa by 1 (step S135), and determines whether or not the value of the variable Fa is K (step S136).

When it is determined that the value of the variable Fa is not K (S136: NO), the device control unit 23 executes step S132 again and specifies a period to which the communication determination time of the next received communication frame belongs. As described above, K periods to which communication determination times of K communication frames belong are specified.

When it is determined that the value of the variable Fa is K (S136: YES), the device control unit 23 specifies a belonging range to which the communication determination time belongs in one cycle based on the specified K periods (step S137). Specifying the belonging range by the device control unit 23 is the same as specifying the belonging range by the equipment control unit 33 of the in-vehicle equipment 3a. Then, the device control unit 23 sets the value of the variable Fa to zero (step S138), and increments the value of the variable Ga by 1 (step S139). After executing step S139, the device control unit 23 determines whether or not the value of the variable Ga is N (step S140).

When it is determined that the value of the variable Ga is not N (S140: NO), the device control unit 23 executes step S132 again. The device control unit 23 newly specifies K periods to which the communication determination time belongs, and newly specifies a belonging range based on the specified K periods. As described above, the device control unit 23 specifies the belonging range N times. When it is determined that the value of the variable Ga is N (S140: YES), the device control unit 23 determines the entire period of the in-vehicle equipment 3a based on the specified N belonging ranges (step S141). Specifying the entire period by the device control unit 23 is the same as specifying the entire period by the equipment control unit 33 of the in-vehicle equipment 3a.

Then, the device control unit 23 adjusts the open period of each of the first queue Q1 and the second queue Q2 of the transmission buffer Ta based on the entire period determined in step S141 (step S142). The adjustment of the open period is an adjustment of the start time or length of the open period. In one cycle, a period other than the open period is a close period. Therefore, when the start time and length of the open period are determined, the start time and length of the close period are automatically determined. Each of the pieces of in-vehicle equipment 3a. 3b, and 3c transmits the first relay frame or the second relay frame when the count value of the slave counter 30 is the transmission instruction value indicated by the transmission instruction value data.

In step S142, the device control unit 23 adjusts, for the transmission buffer Ta, the start time or length of the open period of the first queue Q1 so that the relay determination times of all the first relay frames whose transmission destination is the in-vehicle equipment 3a belong to the open period of the first queue Q1. In addition, the device control unit 23 adjusts, for the transmission buffer Ta, the start time or length of the open period of the second queue Q2 so that the relay determination times of all the second relay frames whose transmission destination is the in-vehicle equipment 3a belong to the open period of the second queue Q2. After executing step S142, the device control unit 23 ends the period adjustment processing.

The period adjustment processing of each of the transmission buffers Tb and Tc is the same as the period adjustment processing of the transmission buffer Ta. The in-vehicle equipment 3a corresponds to the pieces of in-vehicle equipment 3b and 3c. The variable Fa corresponds to the variables Fb and Fc. The variable Ga corresponds to the variables Gb and Gc.

### Effects of Communication System

The communication system 1 according to the fourth embodiment similarly has the effects of the communication system 1 according to the first embodiment except for the effect obtained by adjusting the transmission instruction value of the relay frame.

In addition, in the fourth embodiment, the pattern data in the second embodiment may be used.

### Modification Examples of First to Fourth Embodiments

In the first to fourth embodiments, each of the device communication ICs 21a, 21b, and 21c has a processing element that performs processing. Each of the device communication ICs 21a, 21b, and 21c may perform some of the above-described processes performed by the device control unit 23 instead of the device control unit 23. In this case, all of the device communication ICs 21a, 21b, and 21c and the device control unit 23 or one of the device communication ICs 21a, 21b, and 21c functions as a processing section or a relay processing unit. Similarly, the equipment communication IC 31 has a processing element that performs processing. The equipment communication IC 31 may execute some or all of the above-described processes performed by the equipment control unit 33 instead of the equipment control unit 33. In this case, both the equipment communication IC 31 and the equipment control unit 33 or the equipment communication IC 31 functions as a communication processing unit.

The transmission instruction value of the communication frame may be a value other than zero. In addition, when the variation width of the communication determination time is small, N may be 1. In this case, the calculation value of the entire period is determined to be, for example, the median value of the specified belonging range. In addition, each of the pieces of in-vehicle equipment 3a, 3b, and 3c may transmit a plurality of first relay frames during the open period of the first queue Q1. Similarly, each of the pieces of in-vehicle equipment 3a, 3b, and 3c may transmit a plurality of second relay frames during the open period of the second queue Q2.

The processing performed when the relay determination time belongs to the close period is not limited to discarding the relay frame, but may be suspending the transmission of the relay frame. In this case, for example, no relay frame is transmitted until the next open period arrives. When the next open period arrives, a relay frame whose transmission is pending is transmitted. The number of queues for relay frames provided in each of the transmission buffers Ta, Tb, and Tc is not limited to two, and may be three or more. The number of pieces of in-vehicle equipment connected to the relay device 2 is not limited to three, and may be four or more.

It should be considered that the first to fourth embodiments disclosed are examples in all points and not restrictive. The scope of the present invention is defined by the claims rather than the meanings set forth above, and is intended to include all modifications within the scope and meaning equivalent to the claims.

Specific examples of communication systems according to embodiments of the present disclosure will be described below with reference to the diagrams. In addition, the present invention is not limited to these examples but is defined by the claims, and is intended to include all modifications within the meaning and scope equivalent to the claims.

1. A relay device for relaying communication, comprising:
a receiving circuit that receives communication data from a communication device;
a storage unit that stores the communication data received by the receiving circuit; and
a processing circuit that performs processing,
wherein a first period and a second period are alternately set, and
the processing circuit changes the total number of the first periods and the second periods included in a next predetermined period each time a predetermined period including the first periods and the second periods passes,
determines whether or not the communication data is stored in the storage unit,
and specifies a period to which a communication determination time at which the determination has been performed belongs, from the first period and the second period, when it is determined that the communication data is stored in the storage unit.

2. The relay device according to claim 1,
wherein the processing circuit changes the total number in each predetermined period so that the total numbers in a plurality of consecutive predetermined periods are different,
and changes a position of a boundary between the first period and the second period in each predetermined period so that the positions of the boundaries in the plurality of predetermined periods are different.

3. The relay device according to claim 1,
wherein the processing circuit changes the total number in each predetermined period so that the total numbers in a plurality of consecutive predetermined periods are different, and repeats the plurality of predetermined periods a plurality of times.

4. The relay device according to claim 1,
wherein the receiving circuit receives the communication data from the communication device each time the predetermined period passes, and
the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

5. The relay device according to claim 4,
wherein the receiving circuit receives relay data for relaying,
the received relay data is stored in the storage unit,
a permitted period during which transmission of the relay data is permitted and a prohibited period during which transmission of the relay data is prohibited are alternately set, and
the processing circuit determines whether or not the relay data is stored in the storage unit, specifies a period to which a relay determination time at which the determination has been performed belongs, from the permitted period and the prohibited period, when it is determined that the relay data is stored in the storage unit, gives an instruction to transmit the relay data when the specified period is the permitted period, and adjusts a starting time or length of the permitted period based on the determined entire period.

6. A communication system, comprising:
a communication device that transmits data; and
a relay device that receives data from the communication device and transmits the received data,
wherein the communication device has a communication processing circuit that performs processing, the communication processing circuit gives an instruction to transmit communication data to the relay device,
the relay device includes:
a relay receiving circuit that receives the communication data from the communication device;
a relay storage unit that stores the communication data received by the relay receiving circuit; and
a relay processing circuit that performs processing,
a first period and a second period are alternately set, and
the relay processing circuit changes the total number of the first periods and the second periods included in a next predetermined period each time a predetermined period including the first periods and the second periods passes,
determines whether or not the communication data is stored in the relay storage unit,
and specifies a period to which a communication determination time at which the determination has been performed belongs, from the first period and the second period, when it is determined that the communication data is stored in the relay storage unit.

7. The communication system according to claim 6,
wherein the communication processing circuit gives an instruction to transmit the communication data to the relay receiving circuit each time the predetermined period passes,
the relay processing circuit changes the total number in each predetermined period so that the total numbers in a plurality of consecutive predetermined periods are different, and
the communication processing circuit specifies a belonging range to which the communication determination time belongs in the predetermined period, based on a plurality of specifying results specified by the relay processing circuit regarding a period, when the plurality of predetermined periods pass, and determines an entire period from when the instruction to transmit the communication data is given to the communication determination time based on the specified belonging range.

8. The communication system according to claim 7,
wherein the communication processing circuit gives an instruction to transmit relay data for relaying to the relay receiving circuit,
the relay data received by the relay receiving circuit is stored in the relay storage unit,
a permitted period during which transmission of the relay data is permitted and a prohibited period during which transmission of the relay data is prohibited are alternately set,
the relay processing circuit determines whether or not the relay data is stored in the relay storage unit, specifies a period to which a relay determination time at which the determination has been performed belongs, from the permitted period and the prohibited period, when it is determined that the relay data is stored in the relay storage unit, and gives an instruction to transmit the relay data when the specified period is the permitted period, and
the communication processing circuit determines a transmission instruction time at which an instruction to transmit the relay data is given based on the determined entire period.

9. The communication system according to claim 7,
wherein the relay processing circuit gives an instruction to transmit the communication data received by the relay receiving circuit to the communication device when the specified period is the first period, and discards the communication data received by the relay receiving circuit when it is determined that the specified period is the second period, and
the communication processing circuit specifies a belonging range to which the communication determination time belongs in the predetermined period, based on a plurality of results of receiving the communication data, when the plurality of predetermined periods pass.

10. A processing method of a relay device that relays communication and includes a receiving circuit for receiving communication data from a communication device and a storage unit for storing the communication data received by the receiving circuit, the processing method causing a computer to execute:
a step of changing the total number of first periods and second periods, which are alternately set, included in a next predetermined period each time a predetermined period including the first periods and the second periods passes;
a step of determining whether or not the communication data is stored in the storage unit; and
a step of specifying a period to which a communication determination time at which the determination has been performed belongs, from the first period and the second period, when it is determined that the communication data is stored in the storage unit.

11. The relay device according to claim 2,
wherein the processing circuit changes the total number in each predetermined period so that the total numbers in a plurality of consecutive predetermined periods are different, and repeats the plurality of predetermined periods a plurality of times.

12. The relay device according to claim 1,
wherein the receiving circuit receives the communication data from the communication device each time the predetermined period passes, and
the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

13. The communication system according to claim 8, wherein the relay processing circuit gives an instruction to transmit the communication data received by the relay receiving circuit to the communication device when the specified period is the first period, and discards the communication data received by the relay receiving circuit when it is determined that the specified period is the second period, and
the communication processing circuit specifies a belonging range to which the communication determination time belongs in the predetermined period, based on a plurality of results of receiving the communication data, when the plurality of predetermined periods pass.

14. The relay device according to claim 1, wherein the processing circuit changes the total number in each predetermined period so that the total numbers in a plurality of consecutive predetermined periods are different, and changes a position of a boundary between the first period and the second period in each predetermined period so that the positions of the boundaries in the plurality of predetermined periods are different; and
wherein the receiving circuit receives the communication data from the communication device each time the predetermined period passes, and the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

15. The relay device according to claim 1, wherein the processing circuit changes the total number in each predetermined period so that the total numbers in a plurality of consecutive predetermined periods are different, and repeats the plurality of predetermined periods a plurality of times; and
wherein the receiving circuit receives the communication data from the communication device each time the predetermined period passes, and the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

16. The relay device according to claim 2,
wherein the receiving circuit receives the communication data from the communication device each time the predetermined period passes, and
the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.

17. The relay device according to claim 3,
wherein the receiving circuit receives the communication data from the communication device each time the predetermined period passes, and
the processing circuit changes the total number in each predetermined period so that the total numbers in a plurality of consecutive predetermined periods are different, specifies a belonging range to which the communication determination time belongs in the predetermined period, based on a plurality of specifying results regarding a period, when the plurality of predetermined periods pass, and determines an entire period from when an instruction to transmit the communication data is given from the communication device to the communication determination time based on the specified belonging range.
